(19) United States
(12) Patent Application Publication
(10) Pub. No.: US 2006/0206814 A1
(43) Pub. Date: Sep. 14, 2006

(54) Electronic document creation support apparatus and an electronic document creation support data component creating apparatus

(75) Inventors: Masaki Tonomura, Kanagawa (JP); Masako Mameda, Kanagawa (JP); Noriaki Wada, Kanagawa (JP); Toshio Shimada, Kanagawa (JP); Satoru Okiyama, Kanagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/417,179

(22) Filed: May 4, 2006

Related U.S. Application Data
(62) Division of application No. 09/626,966, filed on Jul. 27, 2000.

(30) Foreign Application Priority Data
Aug. 5, 1999 (JP) H11-223057

(51) Int. Cl. G06F 17/00; G06F 7/00

(52) U.S. Cl. 715/530; 707/100; 715/507

(57) ABSTRACT

Several components include a model document file, a help file describing an explanatory text as to this model document file, a component specific wizard program or a script file for screen definition for general purpose wizard for to be used for setting concrete information to items in this model document file, and a component information file for associating these with one another. When any of the components is selected and then a help button is pressed, a component select program reads the help file associated with the component and displays the same. When a creation button is pressed, the component select program activates the wizard program associated with the component to set concrete information to items in the model document file.

### CROSS-REFERENCE TO RELATED APPLICATIONS

This patent application is a divisional of application Ser. No. 09/626,966, filed on Jul. 27, 2000, which claims the benefit of Japanese Patent Application No. H11-223057 filed on Aug. 5, 1999. The disclosures of the foregoing applications are incorporated herein by reference.

### BACKGROUND OF THE INVENTION

1. Field of the Invention

The invention relates to an electronic document creation support apparatus for providing an environment in which its operator can create electronic documents easily. The invention also relates to a computer readable medium containing electronic document creation support data component and program for operating a computer as the electronic document creation support apparatus mentioned above. Furthermore, the invention relates to an electronic document creation support data component creating apparatus for providing an environment in which the electronic document creation support data component can be created.

2. Description of the Related Art

Conventionally, various types of-electronic documents are created by using computers. The electronic documents created with computers include word processor documents and spreadsheets whose texts are simply printed to be read by a man, as well as source programs to be decoded and compiled into programs by compilers and class definition documents for object-oriented programs such as Java.

Newly creating such electronic documents from scratch requires enormous processes of operation. Therefore, in a technique used widely, “model documents” obtained by generalizing the concrete expressions in electronic documents of same types created in the past are prepared in advance, so that new electronic documents are created by modifying those generalized expressions in the “model documents” into concrete expressions and/or adding/deleting appropriate expressions to/from the same.

Nevertheless, when creating an electronic document to be decoded by a compiler program for example, the operator probably cannot recognize what the individual expressions in the electronic document serving as a “model document” mean immediately. Even in the cases of creating an electronic document to be created for human reading, the operator may have difficulty in recognizing contents of the “model document” immediately, if the contents are sophisticated and complicated.

For this reason, a conventional “model document” contains comment statements written in such form that operators and compilers can distinguish them from the main text. These comment statements describe the meanings of documents corresponding to the “model document”, how to create them, what the individual expressions in the “model document” mean, and the like. The operator, in creating a concrete electronic document from this “model document”, can refer to these comment statements displayed on a word processor dialog or an editor dialog with the main text of the “model document,” to create the concrete electronic document relatively easily.

Such comment statements, however, are not the main text of an electronic document itself, and remain nothing but foreign elements. This can cause the trouble that the comment statements make the content of the “model document” difficult to understand. For example, if comment statements are increased in amount for providing detailed explanations, it becomes difficult to distinguish the main text within the “model document.” Besides, the necessity of the comment statements decreases with increasing operator experience, whereas the comment statements are still displayed on the word processor dialog or the editor dialog irrespective of the operator-side circumstances. Therefore, to highly experienced operators, comment statements offer little merits but only a great demerit of making the main text difficult to be distinguish.

In addition, certain types of electronic documents contain crucial items to be set with concrete values individually. Even if so instructed in the comment statements of “model documents,” whether or not to refer to the comment statements and whether or not to follow the comment statements depend only on the operator. Therefore, it is not certain that the operator follows the comment statements of the “model documents” to set concrete values into the crucial items.

### SUMMARY OF THE INVENTION

The present invention has been achieved in view of the conventional problems as described above. It is thus a first object of the present invention to provide an electronic document creation support apparatus for displaying the explanatory text corresponding to a “model document” only when desired by the operator, a computer readable medium containing electronic document creation support data component and program for operating a computer as such an electronic document creation support apparatus, and an electronic document creation support data component creating apparatus for creating this electronic document creation support data component.

In addition, a second object of the present invention is to provide an electronic document creation support apparatus capable of making the operator enter the crucial items into a model document, a computer readable medium containing electronic document creation support data component and program for operating a computer as such an electronic document creation support apparatus, and an electronic document creation support data component creating apparatus for creating this electronic document creation support data component.

In order to achieve the first object described above, the electronic document creation support apparatus according to a first aspect of the present invention comprises an input device, a display unit for displaying information, a processing unit for reading a program to execute processing according to this program, a first storage medium, a second storage medium containing an editing program, and a third storage program containing a support program. The first storage medium contains a model of the electronic document model, explanatory text data describing an explanatory text for the model, and model specific data including specific information as to the model and the explanatory text data. The editing program makes the processing unit perform edit on the electronic document. The support program makes the processing unit read the model specific data. When a request for an explanatory text is entered through the input device, the support program makes the processing unit read the explanatory text data corresponding to the specific information as to the explanatory text data in the model specific data to display the explanatory text on the display unit. When request of edit on an electronic document is entered through the input device, the support program makes the processing unit perform the edit according to the editing program on the model corresponding to the specific information in the model specific data.

In such configuration, the processing unit reads in the model specific data. Therefore, if only the operator enters a request for an explanatory text through the input device, the explanatory text as to the model, designated by the model specific data are displayed on the display unit. If only the operator enters an request of edit on an electronic document through the input device, the model designated by the model specific data is edited in accordance with the editing program. As a result, the operator can make the explanatory text displayed on the display unit pro re nata, whereby it becomes unnecessary to have comment statements inserted into the model of an electronic document. This avoids the trouble that the comment statements rather make the content of the model difficult to understand. Note that the first through third storage media may be constituted as physically-separated storage devices, and may be formed as different sections in an identical storage device.

When a designation for selecting any one of a plurality of model specific data stored in the first storage medium is input through the input device, the support program may make the processing unit read the model specific data selected. Therefore, when a request for an explanatory text is entered through the input device, the support program makes the processing unit read the explanatory text data corresponding to the specific information as to the explanatory text data in the read model specific data to display the explanatory text via the display unit. When a request of edit on an electronic document is entered through the input device, the support program makes the processing unit perform the edits by the editing program on the electronic document model corresponding to the specific information as to the model in the read model specific data. In such configuration, the operator can select one from among the plurality of models at will to edit the model selected. This makes creation of electronic documents easier.

The computer readable medium according to the first aspect of the present invention contains a model of an electronic document, explanatory text data describing an explanatory text for model, model specific data including specific information as to the model and the explanatory text data, and a support program. The support program makes a processing unit, which is connected to an input device and a display unit and capable of editing the electronic document in accordance with an editing program, read the model specific data. When a request for the explanatory text is entered through the input device, the support program makes the processing unit read the explanatory text data corresponding to the specific information as to the explanatory text data in the model specific data to display the explanatory text on the display unit. When request of edit on an electronic document is entered through the input device, the support program makes the processing unit perform the edit according to the editing program on the model corresponding to the specific information in the model specific data.

In order to achieve the second object described above, the electronic document creation support apparatus according to a second aspect of the present invention comprises an input device, a display unit for displaying information, a processing unit for reading a program to execute processing according to this program, a first storage medium, a second storage medium containing an editing program, and a third storage medium containing a support program. The first storage medium contains a model of the electronic document, item entry support data, and model specific data. The model includes a plurality of items to be filled with concrete information. The item entry support data makes the processing unit set data entered through the input device to a specific item in the model. The model specific data includes specific information as to the model and the item entry support data. The editing program makes the processing unit edit the electronic document. The support program makes the processing unit read the model specific data. When request of edit on an electronic document is entered through the input device, the support program makes the processing unit read the electronic document model and the item entry support data corresponding to the respective specific information in the model specific data, and subject the model to the setting of concrete information into items according to the item entry support data and the edit with the editing program.

In such configuration, the processing unit reads in the model specific data. Therefore, the item to be filled with concrete information in the model designated by the model specific data are subjected to the data setting of the concrete information according to the item entry support data designated by the model specific data, and this model is edited with the editing program. As a result, the model of the electronic document undergoes the forceful setting of concrete information to the items in accordance with the item entry support data. Therefore, the electronic document created through the edit has no lack of crucial items. Note that the first through third storage media may be constituted as physically-separated storage devices, and may be formed as different sections in an identical storage device. In addition, the item entry support data may be a program itself, or data to be referred to by another program so that this program makes the processing unit perform desired operations.

When a designation for selecting any one of a plurality of model specific data stored in the first storage medium is input through the input device, the support program may make the processing unit read the model specific data selected. Therefore, when a request of edit on an electronic document is entered through the input device, the support program makes the processing unit read the model and the item entry support program corresponding to the specific information in the read model specific data and subject this model to the setting of concrete information into the items according to the item entry support data and the edit with the editing program. In such configuration, the operator can select any one from among the plurality of models at will to edit the model. This makes creation of electronic documents easier.

The computer readable medium according to the second aspect of the present invention contains a model of an electronic document, item entry support data, model specific data, and a support program. The model includes a plurality of items to be filled with concrete information. The item entry support data makes a processing unit set data entered through an input device, to a specific item in the model. Here, the processing unit is connected to the input device and a display unit, and is capable of editing the electronic document in accordance with an editing program. The model specific data includes specific information as to the model and the item entry support data. The support program makes the processing unit read the model specific data. When request of edit on an electronic document is entered through-the input device, the support program makes the processing unit read the model and the item entry support data corresponding to the specific information in the read model specific data, and subject this model to the setting of concrete information into the items according to the item entry support data and the edit with the editing program.

The electronic document creation support data component creating apparatus according to the first aspect of the present invention comprises an input device, a processing unit for reading a program to execute processing according to this program, a first storage medium containing an electronic document editing program, a second storage medium containing an explanatory text data editing program, and a third storage medium containing a component creation support program. The electronic document editing program makes the processing unit edit a model of an electronic document. The explanatory text data editing program makes the processing unit edit the explanatory text data. The component creation support program makes the processing unit perform the creation of the model with the electronic document editing program when a request of creation of the model is entered through the input device. When a request of creation of the explanatory text data is entered through the input device, the component creation support program makes the processing unit perform the creation of explanatory text data with the explanatory text data editing program. When a request of creation of an electronic document creation support data component is entered through the input device, the component creation support program makes the processing unit create the model specific data including the specific information as to the model created with the electronic document editing program and the explanatory text data created with the explanatory text data editing program.

In such configuration, when the operator enters the request of creation of a model of an electronic document through the input device, the processing unit activates the electronic document editing program in accordance with the component creation support program. Accordingly, the operator can enter various commands and character strings through the input device to create the model in accordance with the electronic document editing program. Besides, when the operator enters the request of creation of explanatory text data through the input device, the processing unit activates the explanatory text data editing program in accordance with the component creation support program. Accordingly, the operator can enter various commands and character strings through the input device to create the explanatory text data in accordance with this explanatory text data editing program. After the model and the explanatory text data are completed as described above, the operator enters the request of creation of an electronic document creation support data component through the input device. Then, the processing unit creates the model specific data including the specific information as to the model and the specific information as to the explanatory text data in accordance with the component creation support program. Note that the first and second storage media may be constituted as physically-separated storage devices, or may be formed as different sections in an identical storage device.

The electronic document creation support data component creating apparatus according to the second aspect of the present invention comprises an input device, a processing unit for reading a program to execute processing according to this program, a first storage medium containing an electronic document editing program, a second storage medium containing an item entry support data editing program, and a third storage unit containing a component creation support program. The electronic document editing program makes the processing unit edit the electronic model. The item entry support data editing program makes the processing unit edit the item entry support data. The component creation support program makes the processing unit perform the creation of the model with the electronic document model by the electronic document editing program when request of creating the model is entered through the input device. When a request of creating the item entry support data is entered through the input device, the component creation support program makes the processing unit perform the creation of the item entry support data with the item entry support data editing program. When a request of creation of an electronic document creation support data component is entered through the input device, the component creation support program makes the processing unit create the model specific data including the specific information as to the model created with the electronic document editing program and the item entry support data created with the item entry support data editing program.

In such configuration, when the operator enters the request of creation of a model of an electronic document through the input device, the processing unit activates the electronic document editing program in accordance with the component creation support program to. Accordingly, the operator can enter various commands and character strings through the input device to create the model in accordance with this electronic document editing program. Besides, when the operator enters the request of creation of item entry support data through the input device, the processing unit activates the item entry support data editing program in accordance with the component creation support program. Accordingly, the operator can enter various commands and character strings through the input device to create the item entry support data in accordance with this item entry support data editing program. After the model and the item entry support data are completed as described above, the operator enters the request of creation of an electronic document creation support data component through the input device. Then, the processing unit creates the model specific data including the specific information as to the model and the specific information as to the item entry support data in accordance with the component creation support program. Note that the first and second storage media may be constituted as physically-separated storage devices, or may be formed as different sections in an identical storage device.

### BRIEF DESCRIPTION OF THE DRAWINGS

The invention will be described below in detail with reference to the accompanying drawings, in which:

FIG. 1 is a block diagram showing the general configuration of an electronic document creation support system in an embodiment of the present invention;

FIG. 2 is a block diagram showing the software configuration in a component creating computer;

FIG. 3 is a flowchart showing the processing by a component creation support program;

FIG. 4 is a flowchart showing the processing by a creation support program for screen definition for general purpose wizard;

FIG. 5 is a flowchart showing the processing by a model document item display module;

FIG. 6 is a configuration diagram of a dialog for component creation;

FIG. 7 is a configuration diagram of a file/path select dialog;

FIG. 8 is a configuration diagram of the dialog for model 25 creation application by a table editor;

FIG. 9 is a configuration diagram of the dialog for model creation application by a word processor;

FIG. 10 is a configuration diagram of a dialog for help creation application;

FIG. 11 is a configuration diagram of a dialog for creation support as to screen definition for general purpose wizard in the case where the model document file is a class definition document;

FIG. 12 is a configuration diagram of the dialog showing items in model document definition creation support dialog in the case where the model document file is the class definition document;

FIG. 13 is a configuration diagram of the script file for screen definition in the case where the model document file is the class definition document;

FIG. 14 is a configuration diagram of a dialog for creation support as to screen definition for general purpose wizard in the case where the model document file is a word processor document;

FIG. 15 is a configuration diagram of the dialog showing items in model document in the case where the model document file is the word processor document;

FIG. 16 is a configuration diagram of the script file for screen definition in the case where the model document file is the word processor document;

FIG. 17 is a configuration diagram of the component information file in the case where the model document file is the class definition document;

FIG. 18 is a block diagram showing the software configuration in an electronic document creating computer.

FIG. 19 is a flowchart showing the processing by a component list select program;

FIG. 20 is a flowchart showing the processing by a general purpose wizard program;

FIG. 21 is a flowchart showing the processing by a table editor;

FIG. 22 is a configuration diagram of a component list select dialog;

FIG. 23 is a configuration diagram of a help dialog displaying outlines;

FIG. 24 is a configuration diagram of the help dialog displaying details;

FIG. 25 is a configuration diagram of a browser dialog;

FIG. 26 is a configuration diagram of a dialog for general purpose wizard displayed under the script file for screen definition in the case where the model document file is the class definition document;

FIG. 27 is a configuration diagram of a dialog for general purpose wizard displayed under the script file for screen definition in the case where the model document file is the class definition document;

FIG. 28 is a configuration diagram of a dialog for general purpose wizard displayed under the script file for screen definition in the case where the model document file is the class definition document;

FIG. 29 is a configuration diagram of a dialog for general purpose wizard displayed under the script file for screen definition in the case where the model document file is the class definition document;

FIG. 30 is a configuration diagram of a class/interface browse dialog;

FIG. 31 is a configuration diagram of a method addition dialog;

FIG. 32 is a configuration diagram of a dialog for general purpose wizard displayed under the script file for screen definition in the case where the model document file is the word processor document;

FIG. 33 is a configuration diagram of a dialog for general purpose wizard displayed under the script file for screen definition in the case where the model document file is the word processor document;

FIG. 34 is a configuration diagram of the document creation dialog on the completion of the wizard program at the point where the model document file is the class definition document;

FIG. 35 is a configuration diagram of the document creation dialog at the point of the completion of the wizard program in the case where the model document file is the word processor document;

FIG. 36 is a configuration diagram of a document creation diagram in the case where the display mode is “BUSINESS ONLY”;

FIG. 37 is a configuration diagram of the document creation diagram in the case where the display mode is “ALL”; and

FIG. 38 is a diagram showing a drop-down list displayed in an input target field.

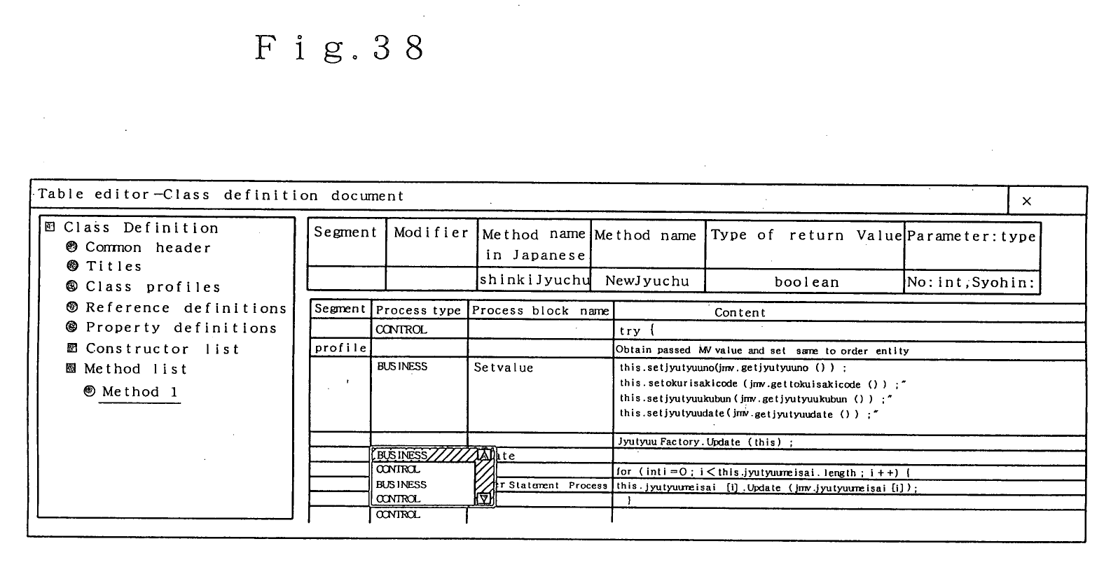

### DETAILED DESCRIPTION OF THE PREFERRED EMBODIMENTS

Hereinafter, an embodiment of the present invention will be described with reference to the accompanying drawings.

In the embodiment of the present invention to be described below, individual model documents (electronic document models) are associated with help files (explanatory text data) containing the explanations thereof, and wizards (that is, a specific wizard programs designated exclusively for the model document or script file for screen definition for general purpose wizards, i.e., support data for item entry) for making the operator enter crucial items. In the embodiment below, the groups of model documents, help files, and wizards associated with one another will be referred to as “components (electronic document creation support data components),” and will be treated as logically integral. Those files establishing the associations within the components are “component information files (model specific data)” to be described later.

<Configuration of Electronic Document Creation Support System>

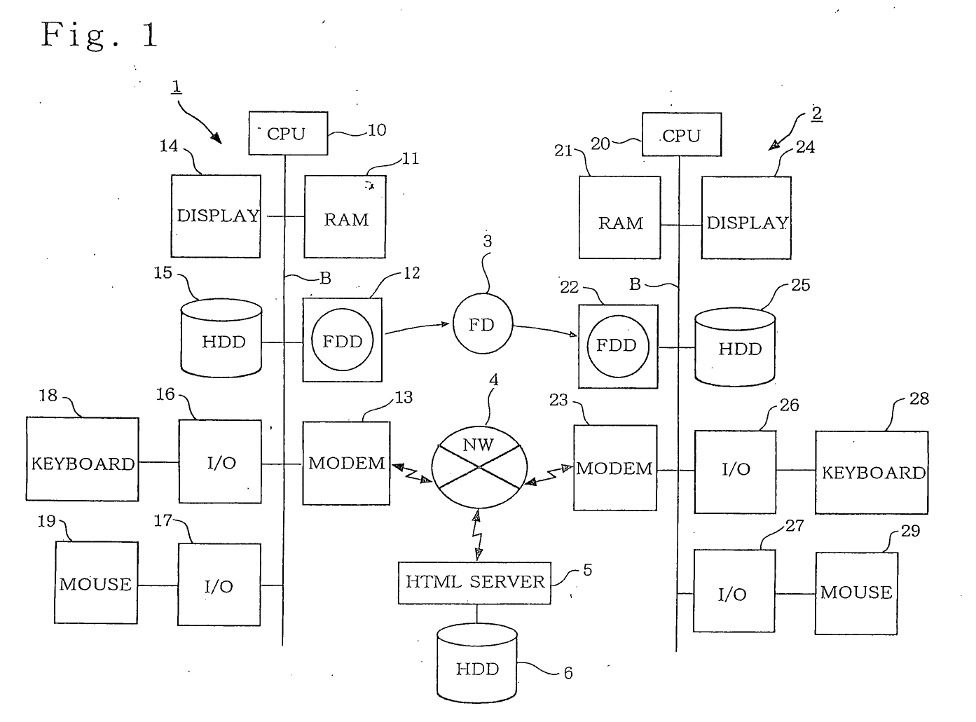

As shown in FIG. 1, an electronic document creation support system, that is a computer system to which the present invention is applied, has a component creating computer (electronic document creation support data component creating apparatus) 1, an electronic document creating computer (electronic document creation support apparatus) 2, and an HTML server 5. The component creating computer 1 creates a component, and stores this component in a floppy disk (FD) 3 or sends the same to the electric document creating computer 2 through a network (NW)4. The electronic document creating computer 2 reads the component from the floppy disk 3 or receives the component through the network 4, and carries out creation of an electronic document by using the component.

The HTML server 5 is connected to the network 4. The HTML server 5 is an internet server for conducting data communication according to the TCP/IP protocol. The HTML server 5 stores the explanatory texts for the components (that is, model documents) created by the component creating computer 1, into a hard disk (HDD) 6 in the form of HTML documents associated with respective URLs. When URL corresponding to any of the HTML documents stored in the hard disk 6 is delivered from the electronic document creating computer 2, the HTML server 5 sends the HTML document corresponding to the URL to the electronic document creating computer 2. Incidentally, even after the components (model documents) have been created once, the HTML documents (explanatory texts) stored in the hard disk 6 on the HTML server 5 will be updated at any time when their contents become relatively old.

Hereinafter, description will be given in detail of the concrete configurations of both the component creating computer 1 and the electronic document creating computer 2 in the electronic document creation support system of the present embodiment.

<Component Creating Computer>

[Hardware Configuration]

As shown in FIG. 1, the component creating computer 1 has a CPU 10, a RAM 11, a floppy disk drive (FDD) 12, a modem 13, a display 14, a hard disk (HDD) 15, and interfaces 16 and 17, which are connected to one another via a bus B. The component creating computer 1 further has a keyboard 18 connected to the interface 16, and a mouse 19 connected to the other interface 17.

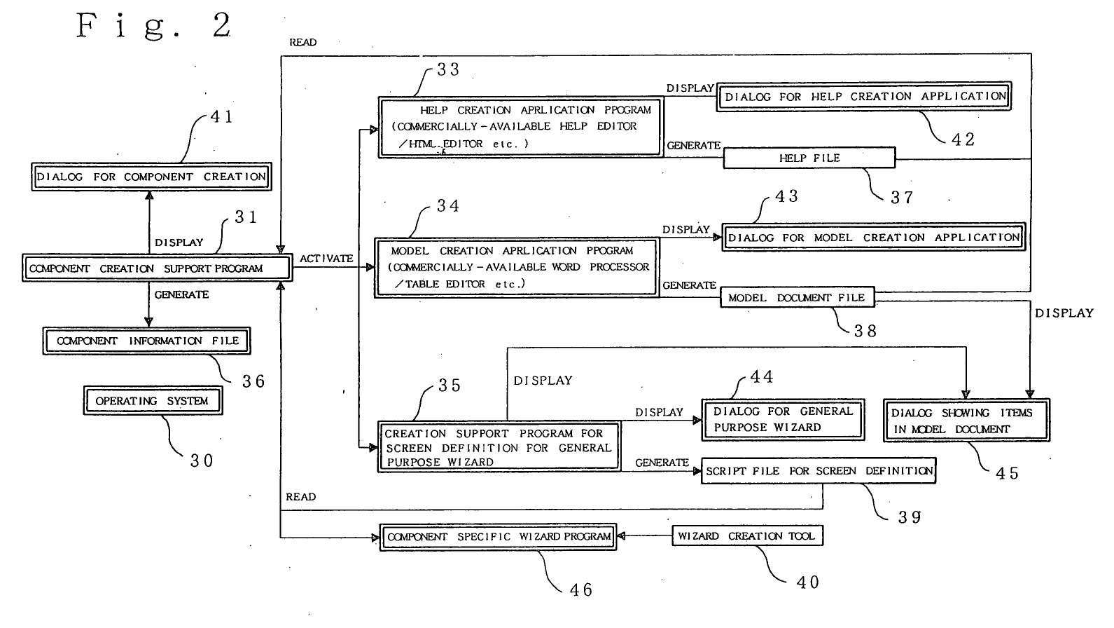

The hard disk 15 is a disk drive tat serves as the computer readable medium containing various programs (an operating system 30, a component creation support program 31, a help creation application program 33, model creation application programs 34, a Creation support program for screen definition for general purpose wizard 35, a wizard creation tool 40, and the like) and various data shown in FIG. 2. Inside of the hard disk 15 is logically sectioned into folders of multilevel hierarchy. In this hard disk 15, those areas (sectors) containing the model creation application programs 34 (that is, electronic document editing programs) correspond to the first storage medium. Those areas (sectors) containing the help creation application program 33 (that is, explanatory text editing program), or the Creation support program for screen definition for general purpose wizard 35 or wizard creation tool 40 (that is, item entry support data editing program) correspond to the second storage medium. Those areas (sectors) containing the component creation support program 31 correspond to the third storage medium.

The CPU 10 is a processing unit which carries out predetermined processing by reading various programs from the hard disk 15 and performing the same. The processes executed by this CPU 10 will be described later in detail.

The RAM 11 is a work memory in which programs read from the hard disk 15 by the CPU 10 are expanded and various files shown in FIG. 2 (for example, a component information file 36, a help file 37, and a script file for screen definition 39).

The floppy disk drive 12 is a disk drive which writes the files created in the RAM 11 by the CPU 10, constituting the respective components (the component information files 36, the help files 37, and the script files for screen definition 39 or component specific wizard program files 47 shown in FIG. 2) to the floppy disk (FD) 3.

The modem 13 is a communication device which converts the files created in the RAM 11 by the CPU 10, constituting the respective components (which are the component information files 36, the help files 37, and the script files for screen definition 39 or the component specific wizard program files 47) into communication signals and sends the same toward the network (NW)4. The modem 13 is used on the precondition that the network 4 consists of ordinary analog lines, and therefore is replaced with a DSU or a LAN adopter depending on the network configuration.

The display unit 14 displays various windows generated by the CPU 10 executing the variety of programs mentioned above (namely, a DIALOG FOR COMPONENT CREATION 41 generated when the component creation support program 31 is executed, a dialog for help creation application 42 generated when the help creation application program 33 is executed, a dialog for model creation applications 43 generated when a model creation application program 34 is executed, and a dialog for creation support as to screen definition for general purpose wizard 44 and a dialog showing items in model document 45 generated when the Creation support program for screen definition for general purpose wizard 35 is executed).

The keyboard 18 is an input device through which the operator of the component creating computer 1 inputs various text. The interface 16 connected between this keyboard 18 and the bus B is an I/O device which converts a signal indicating a pressed key on the keyboard 18 into corresponding code information, and inputs the same to the CPU 10.

The mouse 19 serving as another input device is moved over a plane by the operator to generate a signal indicating its moving direction and moving amount at all times. The mouse 19, having a click button (not shown) to be pressed by the operator, also generates a click signal when the dock button is pressed. These signals are converted into code information by the interface 17, and input to the CPU 10.

[Software Configuration]

Now, referring to FIG. 2, an overview will be given of the variety of programs (which are the operating system 30, the component creation support program 31, the help creation application program 33, the model creation application programs 34, the Creation support program for screen definition for general purpose wizard 35, the wizard creation tool 40, and the like) and the variety of files (which are the component information files 36, the help files 37, and the script files for screen definition 39 or the component specific wizard program files 47) stored in the hard disk 15, and of the various dialogs (which are the dialog for component creation 41, the dialog for help creation application 42, the dialog for model creation applications 43, the dialog for creation support as to screen definition for general purpose wizard 44, the dialog showing items in model document 45, and the like).

The operating system 30 is a basic program which controls the operation of the various types of hardware constituting the component creating computer 1. To be more specific, the operating system 30 is Windows 98 from Microsoft Corp. This operating system 30 makes the CPU 10 display a text entry cursor and a mouse cursor onto the dialog displayed on the display unit 14. The text entry cursor is exclusively displayed in a text box, when the displayed dialog (window) has a text box or text boxes. When a character is entered from the keyboard 18, the operating system 30 makes the CPU 10 write the entered character to the display position of the text entry cursor within the dialog displayed on the display unit 14, as well as shift the text entry cursor by one character. Besides, when a tab key (not shown) on the keyboard 18 is pressed, the operating system 30 makes the CPU 10 move the text entry cursor to another text box in the same dialog. Moreover when a signal indicating the moving direction and the moving amount of the mouse 19 is input, the operating system 30 makes the CPU 10 analyze the moving direction and the moving amount of the mouse 19, and move the mouse cursor displayed on the display unit 14 in accordance with the moving direction and the moving amount. In addition, when a click signal is input, the operating system 30 makes the CPU 10 activate the dialog (window) the mouse cursor is placed on at that time, as well as move the position of the text entry cursor to the display position of the mouse cursor In the cases where the mouse cursor lies on any of the buttons in the dialog when a click signal is input (hereinafter, such context is referred to as “a button is clicked”), the operating system 30 makes the CPU 10 execute processing according to the command associated with the button in advance.

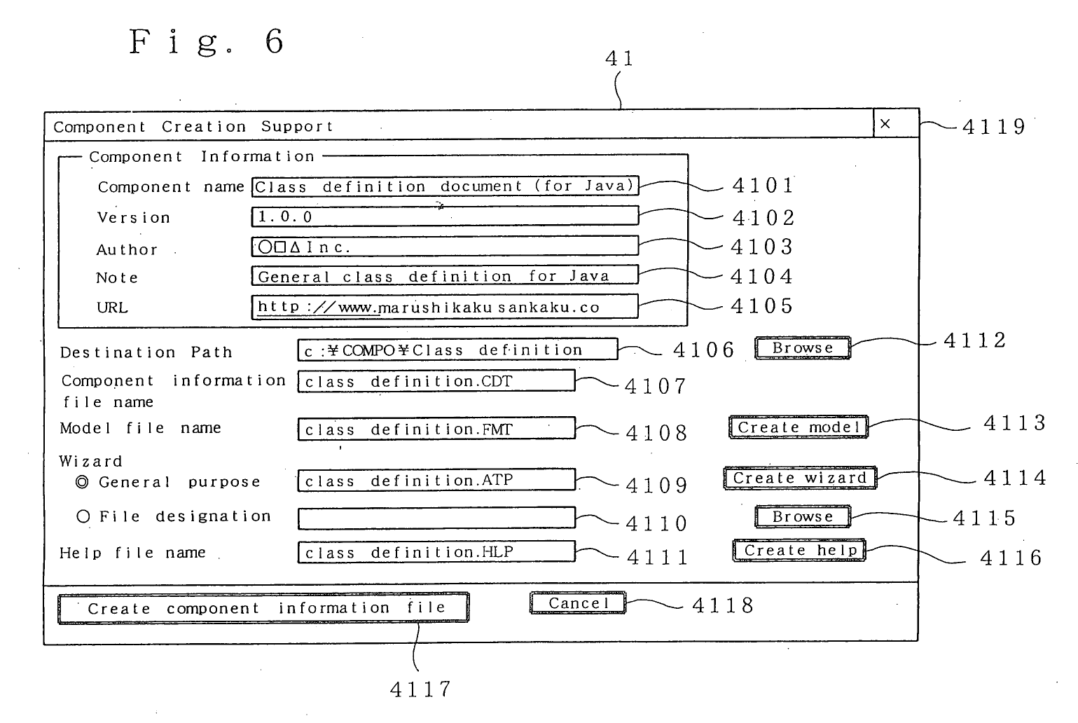

The component creation support program 31 makes the CPU 10 display the dialog for component creation 41 shown in FIG. 6, onto the display unit 14. Then, in accordance with the input the operator makes through the keyboard 18 and the mouse 19, the CPU 10 activates the help creation application program 33, a model creation application program 34, and the Creation support program for screen definition for general purpose wizard 35. Meanwhile, the CPU 10 reads the help file 37 created by the help creation application program 33, the model document file 37 created by the model creation application program 34, and the script file for screen definition 39 created by the Creation support program for screen definition for general purpose wizard 35 or the component specific wizard program file 40 created by the wizard creation tool 40 in advance, to create the component information file 36.

As shown in FIG. 6, the dialog for component creation 41 is a window containing: a close button 4119; text boxes for “Component name” 4101, “Version” 4102, “Author” 4103, “Note” 4104, and “URL” 4105 of a component to be created; text boxes for “Destination path” 4106, “Component information file name” 4107, “Model file” 4108, the script file name of screen definition for general purpose wizard (wizard of “General purpose” 4109), the component specific wizard program file name (wizard of “File designation” 4110), and “Help file name” 4111; and buttons for “Browse” 4112 as to destination path, “Create model” 4112, “Create wizard” 4114, “Browse” 4115 as to file name of component specific wizard program, “Create help” 4116, “Generate component information file” 4117, and “Cancel” 4118.

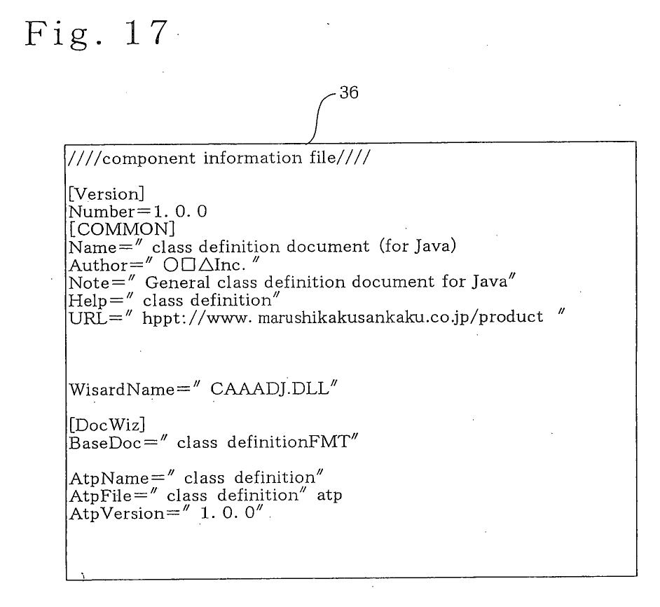

The component information file 36 is a text file. In the file, as shown in. FIG. 17, the entry to the “Version” text box 4102 on the dialog for component creation 41 is written as “[Version]Number.” The entry to the “Component name” text box 4101 is written as “[Common]Name.” The entry to the “Author” text box 4104 is written as “Note.” The entry to the “Help file name” text box 4111 (i.e., the file name of the help file 37) is written as “Help” (i.e., the specific information on the explanatory text data). The entry to the “URL” text box 4105 is written as “URL.” The entry to the “Model file name” text box 4108 (that is, the file name of the model document 38) is written as “[DocWiz]BaseDoc” (that is, the specific information on the electronic document model). The entry to the wizard of “General purpose” text box 4109 (that is, the file name of the script file for screen definition 39) is written as “AtpFile” (that is, the specific information on the item entry support data). The name of the general purpose wizard program 52 corresponding to the script file for screen definition 39 is written as “WizardName.” Here, in the case where the “File designation” is selected on the dialog for component creation 41, the entry to the wizard of “File designation” text box 4110 (that is, the file name of the component specific wizard program 47, i.e., the specific information on the item entry support data) is written to the component information file 36. In the present embodiment, an extension of “CDT” is given to a file name of the component information file 36.

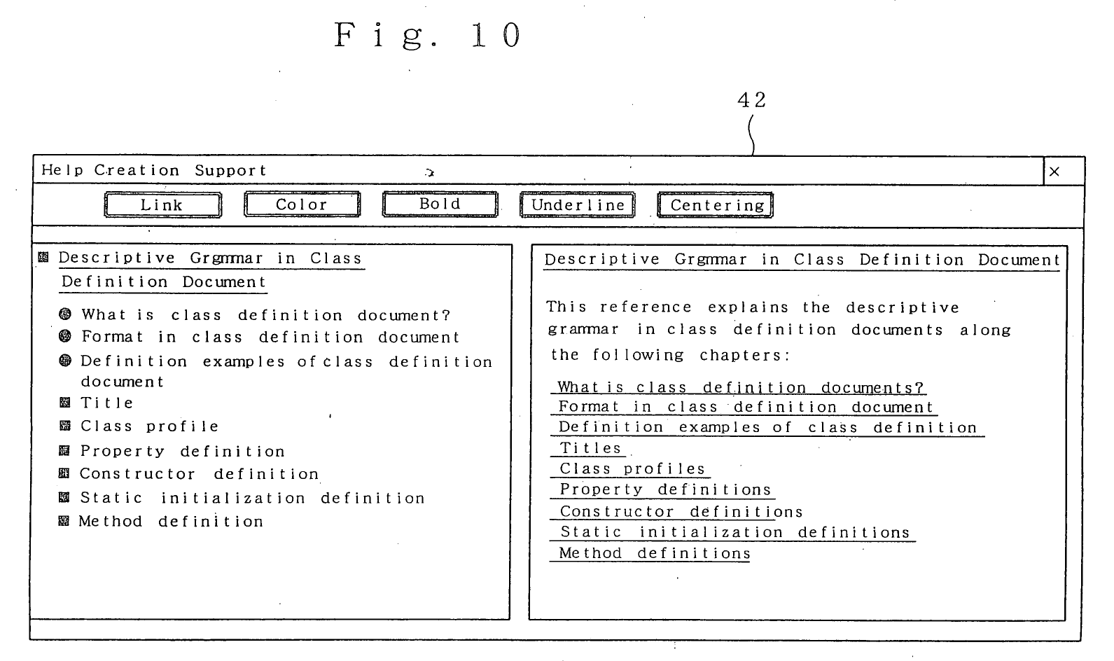

The help creation application program 33 serving as the explanatory text editing program is a commercially-available help editor, HTML editor, or the like. The help creation application program 33 makes the CPU 10 display the window of the dialog for help creation application 43 shown in FIG. 10, onto the display unit 14. On this dialog, the help file 37 (explanatory text data) is edited in accordance with data input by an operator. In the present embodiment, an extension of “HLP” is given to a file name of the help file 37. The help file 37 has a tree structure with the explanatory texts on general items (broad items) at the upper level and the explanatory texts on detailed items (fine items) related to the general items at the lower level of hierarchy. Incidentally, such tree-structure hierarchy is not limited to of two levels, and sometimes is of three levels or more. In the left field of the dialog for help creation application 42, those upper-leveled general items having lower-leveled detailed items are marked with a square.

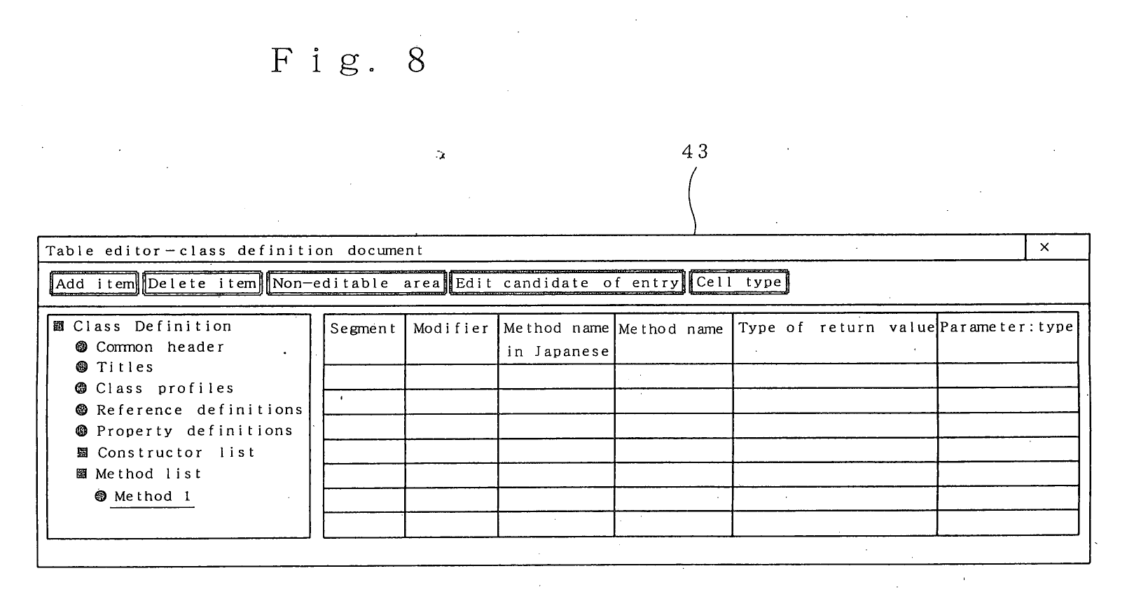

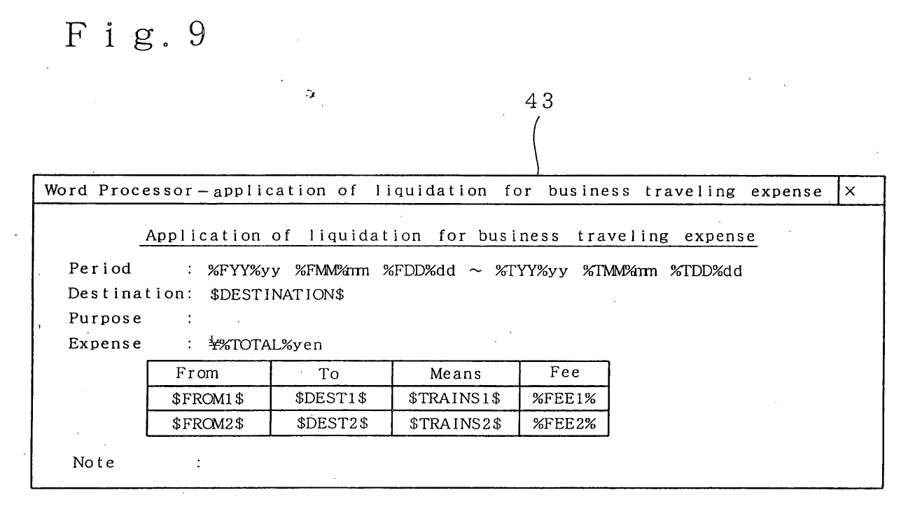

The model creation application programs 34 serving as the electronic document editing programs are commercially-available word processor, table editor, and the like. A model creation application program 34 makes the CPU 10 display the dialog for model creation application 43 onto the display unit 14. On this dialog, the model document file 38 (the electronic document model) is edited in accordance with data input by operator. When the model creation application program 34 is a table editor and the model document file 38 is a Java class definition document, the dialog for model creation application 43 shown in FIG. 8 is displayed. When the model creation application program 34 is a word processor and the model document file 38 is a word processor document “application of liquidation for business traveling expense,” the window shown in FIG. 9 is displayed as the dialog for model creation application 43. In the present embodiment, an extension of “FMT” is given to a file name of the model document file 38 in case it is a Java class definition document, and an extension of “DOC” is given to a file name of the model document file 38 in case it is a word processor document.

The Creation support program for screen definition for general purpose wizard 35 serving as the item entry support data editing program makes the CPU 10 display the dialog for creation support as to screen definition for general purpose wizard 44 onto the display unit 14. On this dialog, the script file for screen definition 39 (the item entry support data) is edited in accordance with data input by an operator. The Creation support program for screen definition for general purpose wizard 35 has a model document item display module. The program 35 makes the CPU 10 extract items to be input from the model document file 38 and display the dialog showing items in model document 45 listing the extracted items onto the display unit 14, in accordance with commands input by an operator editing the script file for screen definition.

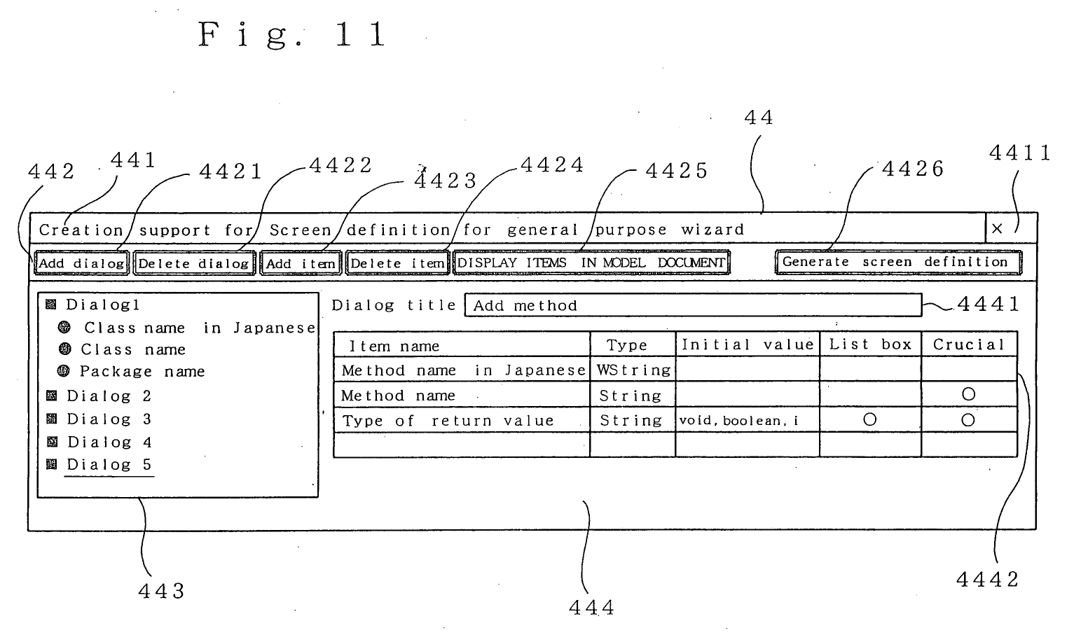

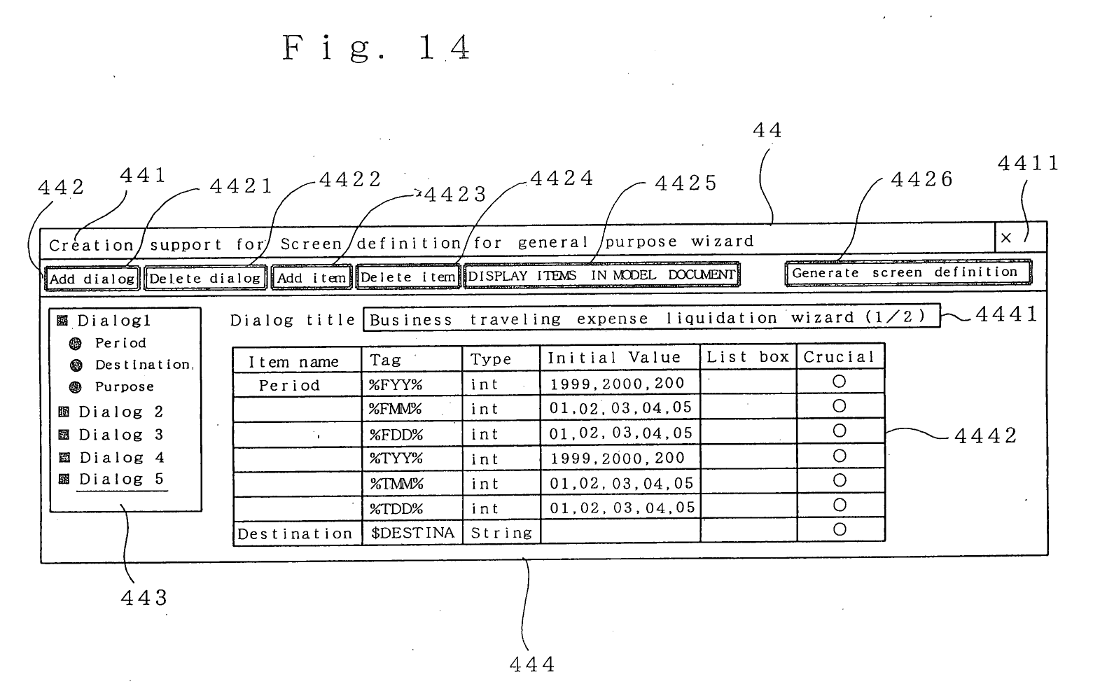

FIG. 11 shows an example of the dialog for creation support as to screen definition for general purpose wizard 44 in the case where the model document file 38 is the Java class definition document. FIG. 14 shows an example of the dialog for screen definition for general purpose wizard creation dialog 44 in the case where the model document file 38 is the word processor document “application of liquidation for business traveling expense.” As shown in these diagrams, the dialog for creation support as to screen definition for general purpose wizard 44 is sectioned into a title bar 441 displayed along the upper border, a tool bar 442 displayed in line therebelow, a tree text box 443 displayed to the left side therebelow, and a dialog-specific detail text box 444 displayed on the remaining area. The title bar 441 displays a dose button 4411. The tool bar 442 displays buttons including “Add dialog” 4421, “Delete dialog” 4422, “Add item” 4423, “Delete item” 4424, “display items in model document” 4425, and “Generate screen definition” 4426. The tree list box 443 is a field in which the numbers of the full dialogs of the wizards to be defined by the script file for screen definition 39 which is being edited and the items to be set in the respective dialogs are shown in a tree structure. The dialog-specific detail text box 444 displays a text box 4441 and an item list 4442. The text box 4441 is to specify the “Dialog title” of the dialog designated by the dialog number dicked in the tree list box 443 (the dialog number underlined). The item list 4442 lists “Item name,” “Tag (in a word processor document only),” “Type,” “Initial value,” the presence/absence of a “list box,” and whether “Entry required” or not, for each of the items to be set in that dialog.

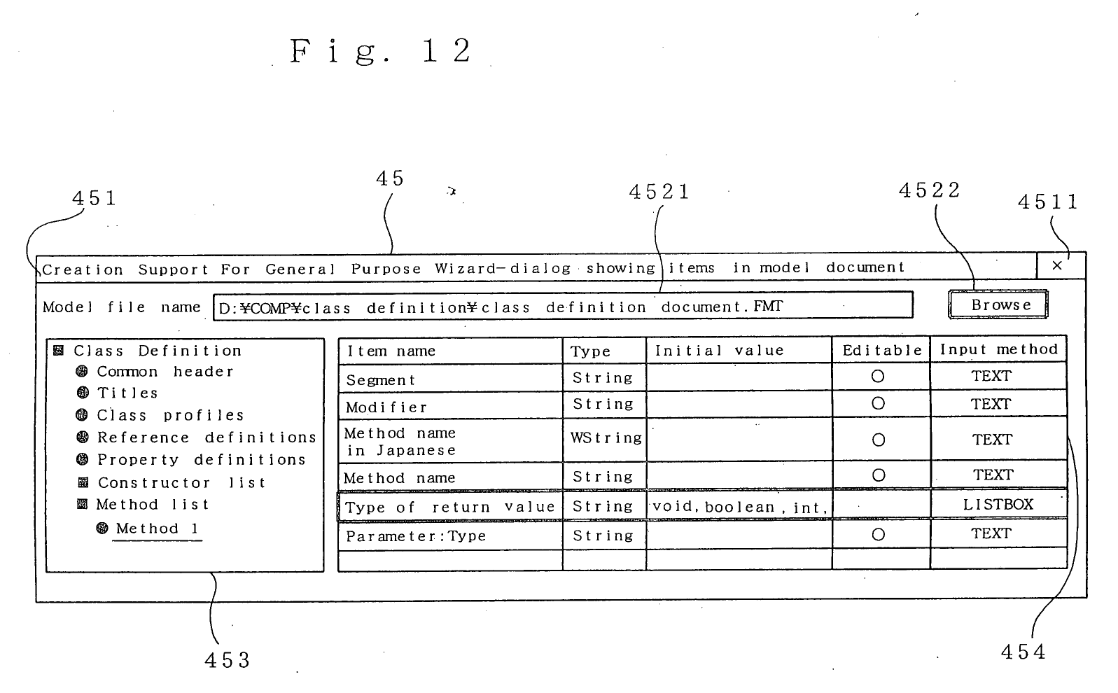

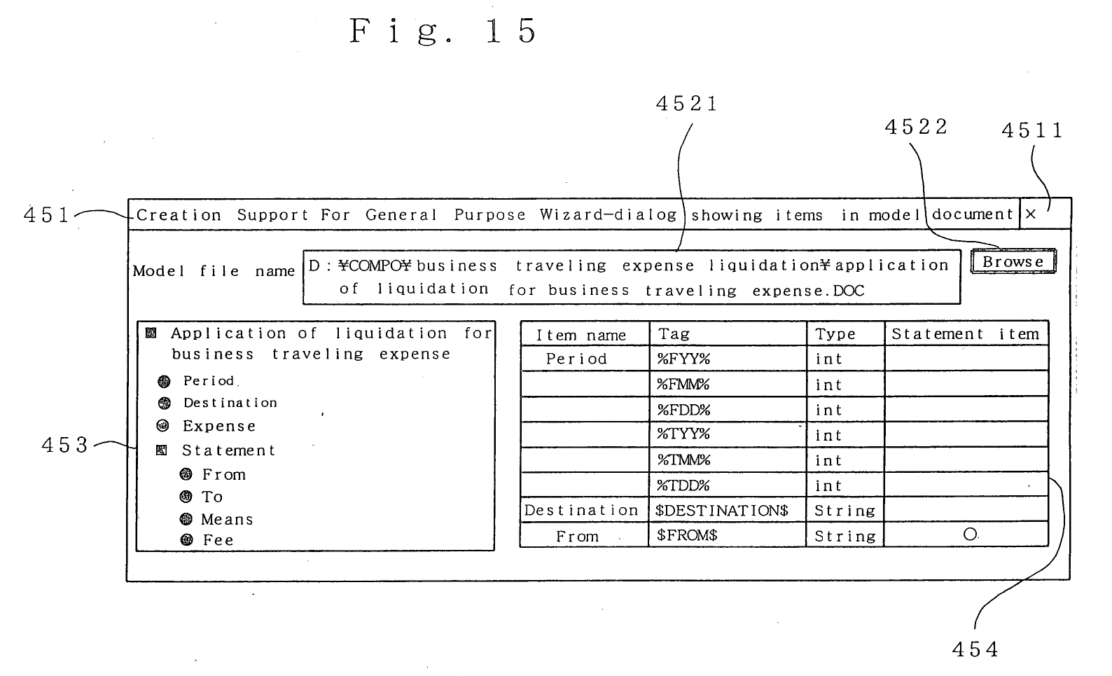

Then, FIG. 12 shows an example of the dialog showing items in model document 45 in the case where the model document file 38 is the Java class definition document. FIG. 15 shows an example of the dialog showing items in model document 45 in the case where the model document file 38 is the word processor document “application of liquidation for business traveling expense.” As shown in these diagrams, the dialog showing items in model document 45 is sectioned into a title bar 451 displayed along the upper border, a “Model file name” text box 4521 and a “Browse” button 4522 displayed in line therebelow, a tree list box 453 displayed to the left side therebelow, and a detail table 454 displayed on the remaining area. The title bar 451 displays a close button 4511. The “Model file name” text box 4521 is a field in which the file name of the model document file 38 to be referred to by the Creation support program for screen definition for general purpose wizard 35 is designated (automatically or arbitrarily). The tree list box 453 is a field in which the item names of the respective items in the model document file 38 specified in the “model file name” text box 4521 are shown in a tree structure. The detail table 454 is a table which lists “Item name,” “Type,” and the like for each item.

The script file for screen definition 39 is a text file. The title of the dialog (“FRAME NAME”) and the contents of the items in the item list 4442 for every dialog (“FRAME”), of which dialog number is displayed in the tree list box 443 in the dialog for creation support as to screen definition for general purpose wizard 44, are listed in the script file 39, in accordance with the specifications of the general purpose wizard program used in the electronic document creating computer 2. In the present embodiment, an extension of “ATP” is given to a file name of the script file for screen definition 39.

The component specific wizard program 47 is a wizard program that is written exclusively for each model document file 38. The component specific wizard program 47 makes the operator enter the crucial items in the model document file 38, in place of the general purpose wizard program 52.

The wizard creation tool 40 serving as the item entry support data editing program is an editor and a compiler for making the CPU 10 create the component specific wizard program 47 (the item entry support data) in accordance with data input by an operator.

[Process Flow]

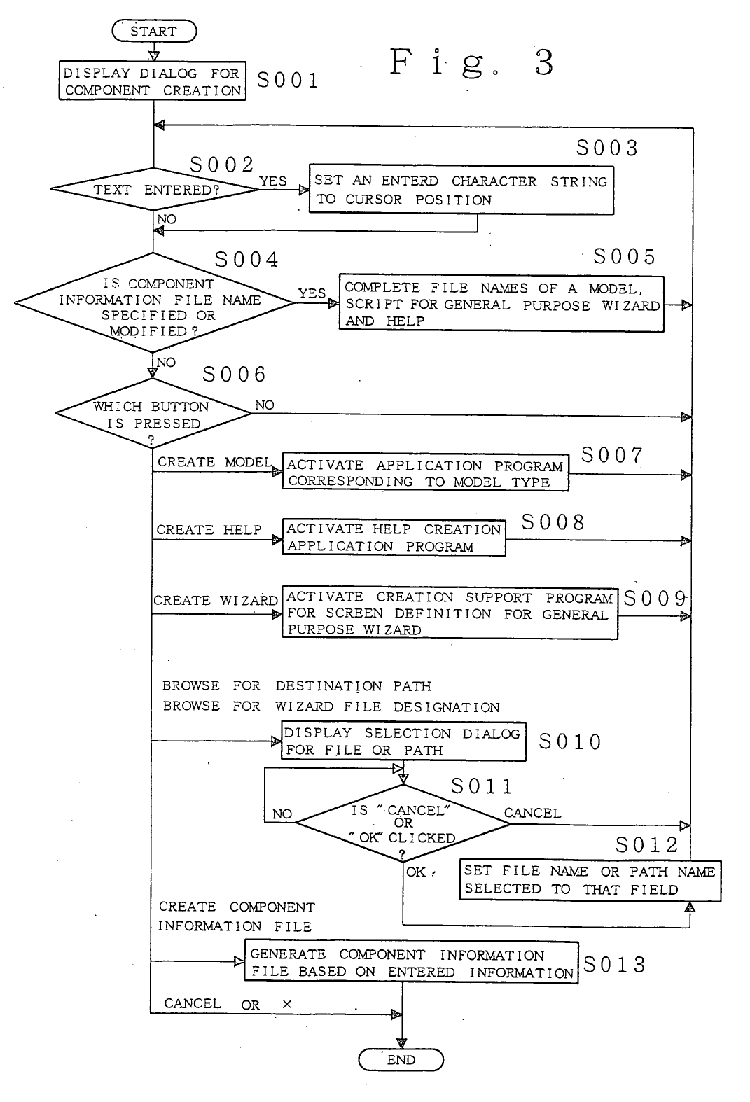

Now, with reference to the flowcharts in FIGS. 3-5, description will be given of the process performed by the CPU 10 having read the above-described variety of programs.

FIG. 3 is a flowchart showing a support process for creating a component performed by the CPL 10 in accordance with the component creation support program 31. At S001 which is the first step since the beginning of this support process for creating a component, the CPU 10 displays the dialog for component creation 41 shown in FIG. 6, onto the display unit 14.

Then, at S002, the CPU 10 utilizes the function of the operating system 30 to check whether or not any new text entry has been made since the previous execution of S002. If any new text entry has been made, the CPU 10 sets (writes) the character string having been entered so far to the display position of the text entry cursor in the dialog for component creation 41, at S003, and then advances processing to S004. At S003, it is possible to set character strings into any of the text boxes 4101-4111 in the dialog for component creation 41. On the other hand, when no text has been entered, the CPU 10 simply advances processing to S004.

At S004, the CPU 10 checks whether or not a new file name is set into the “Component information file name” text box 4107 in the dialog for component creation 41 or an old file name in the “Component information file name” text box 4107 has been changed since the previous execution of S004, as a result of the setting of the text entry at S003. If a new file name is set into the “Component information file name” text box 4107 or the file name having been set is changed, the CPU 10, at S005, removes the extension from the file name currently set in the “Component information file name” text box 4107, and sets the resultant into the “Model file name” text box 4108. Besides, the CPU 10 modifies the file name by changing only the extension into “ATP,” and sets the resultant into the wizard of “General purpose” text box 4109. The CPU 10 also modifies the file name by changing only the extension into “HLP,” and sets the resultant into the “Help file” text box 4111. Having completed this S005, the CPU 10 returns processing to S001. In contrast, when no file name is set in the “Component information file name” text box 4107 or the file name having been set is not changed, the CPU 10 advances processing to S006.

At S006, the CPU 10 checks whether or not any of the buttons 4112-4118 in the component creation supporting dialog 41 is clicked. If none of the buttons is clicked, the CPU 10 returns processing to S001. On the other hand, when any button is clicked, the CPU 10 analyzes the name of the button clicked, and executes the process (S007-S010, S013) according to the name of the button clicked. Hereinafter, description will be made on the clicked buttons and the processes.

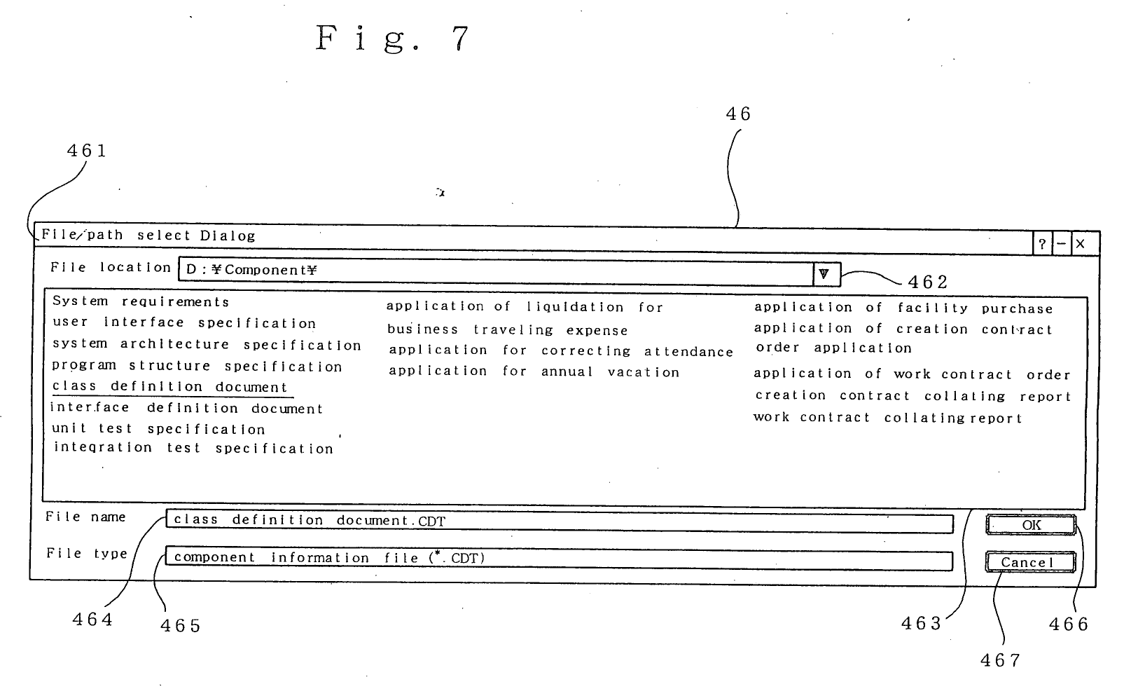

For a start, if either of the “Browse” buttons 4112 and 4115 is clicked, the CPU 10 displays the file/path select dialog 46 shown in FIG. 7 over the dialog for component creation 41 at S010. This file/path select dialog 46 contains a title bar 461 displayed along the upper border, a “File location” text box 462 displayed therebelow, a file name list 463 displayed therebelow, a “File name” text box 464 and a “OK” button 466 displayed in line therebelow, and a “File type” text box 465 and a “Cancel” button 467 displayed in line therebelow. The “File location” text box 465 is a drop-down list box. Thus, its button with a mark of an inverted triangle is clicked, so that the folder structure within the component creating computer 1 is displayed as a tree. Any of the folder names in the tree is clicked, so that the path name of the folder is displayed. Among all the files stored in the folder corresponding to the path name displayed in the “File location” text box 462, those of the type specified in the “File type” text box 465 (of which file name is attached with the specified extension) are listed in the file name list 463 by file name (with the extension omitted), along with the folder names of their subfolders. When any of the file names in the file name list 463 is clicked, the file name (with its extension) is displayed in the “File name” text box 464.

Then, at S011, the CPU 10 waits Until the “OK” button 466 or the “Cancel” button 467 in the file/path select dialog 46 is clicked. If the “Cancel” button 467 is clicked, the CPU 10 simply returns processing to S002. On the other hand, when the “OK” button 466 is clicked, the CPU 10 advances processing to S012.

At S012, the CPU 10 sets the path name displayed in the “File location” text box 462 in the file/path select dialog 46 at that time into the “Destination path” text box 4106 in the dialog for component creation 41, if distinguishing at S006 that the “Browse” button 4112 as to the destination path is clicked. If distinguishing at S006 that the “Browse” button 4115 as to file name of the component specific wizard program file name is clicked, the file name displayed in the “File name” text box 464 in the file/path select dialog 46 at that time (in this case, the file name of any of the component specific wizard programs 47.) is set into the wizard of “File designation” text box 4110 in the dialog for component creation 41.

Having completed this S012, the CPU 10 returns processing to S002.

Meanwhile, if distinguishing at S006 that the “Create model” button 4113 is clicked (i.e., when a create request for an electronic document model is entered), the CPU 10 activates the model creation application program 34 according to the extension of the file name currently set in the “Model file name text box 4108, at S007, and then returns processing to S002. In this connection, immediately after the execution of S005, no processing will be carried out at S007 because the file name set in the “Model file name” text box 4108 has no extension. In contrast, if the operator has entered an extension (“FMT,” “DOC,” or the like) into the “Model file name” text box 4108 with the text entry cursor put behind the file name after the execution of S005, the extension is set for the file name in the “Model file name” text box 4108, so that the model creation application program 34 according to the extension is activated at S007. For example, an extension of “FMT” activates a table editor as the model creation application program 34. An extension of “DOC” activates a word processor as the model creation application program 34.

Activating the model creation application program 34 at S007, the CPU 10 displays a dialog for model creation application 43 over the dialog for component creation 41 in accordance with the model creation application program 34. Then, on this dialog for model creation application 43, the CPU 10 newly creates a model document file 38 in accordance with data input by the operator FIG. 8 shows the dialog for model creation application 43 at the time a model document (class definition document) is being created in the case where the model creation application program 34 is a table editor. FIG. 9 shows the dialog for model creation application 43 at the time a model document (application of liquidation for business traveling expense) is being created in the case where the model creation application program 34 is a word processor. When the model document file 38 is completed on the dialog for model creation application 43 and the “save” command of the model creation application program 34 is issued, the CPU 10 attaches the file name set in the “Model file name” text box 4108 in the dialog for component creation 41 to the model document file 38 created, and writes this model document file 38 into a folder in the hard disk 15, designated by the path name set in the “Destination path” text box 4106.

If distinguishing at S006 that the “Create help” button 4116 is clicked (i.e., when a create request for explanatory text data is entered), the CPU 10 activates the help creation application program 33 at S008, and then returns processing to S002.

Activated the help creation application program 33 at S008, the CPU 10 displays the dialog for help creation application 42 shown in FIG. 10 over the dialog for component creation 41 in accordance with the help creation application program 33. Then, on this dialog for help creation application 42, the CPU 10 newly creates a help file 37 in accordance with data input by the operator. When the help file 37 is completed on the dialog for help creation application 42 and the “save” command of the help creation application program 33 is issued, the CPU 10 attaches the file name set in the “Help file name” text box 4111 in the dialog for component creation 41 to the help file 37 created, and writes this help file 37 into a folder in the hard disk 15, designated by the path name set in the “Destination path” text box 4106.

If distinguishing at S006 that the “Create wizard” button 4114 is clicked (i.e., when a create request for item entry support data is entered), the CPU 10 activates the Creation support program for screen definition for general purpose wizard 35 at S009, and then returns processing to S002.

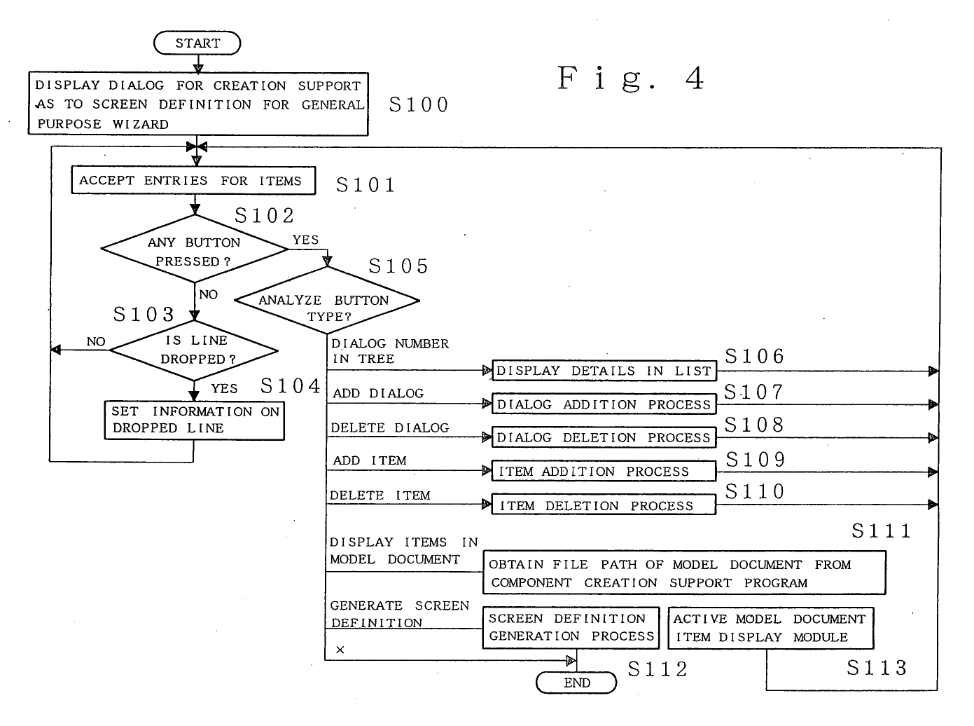

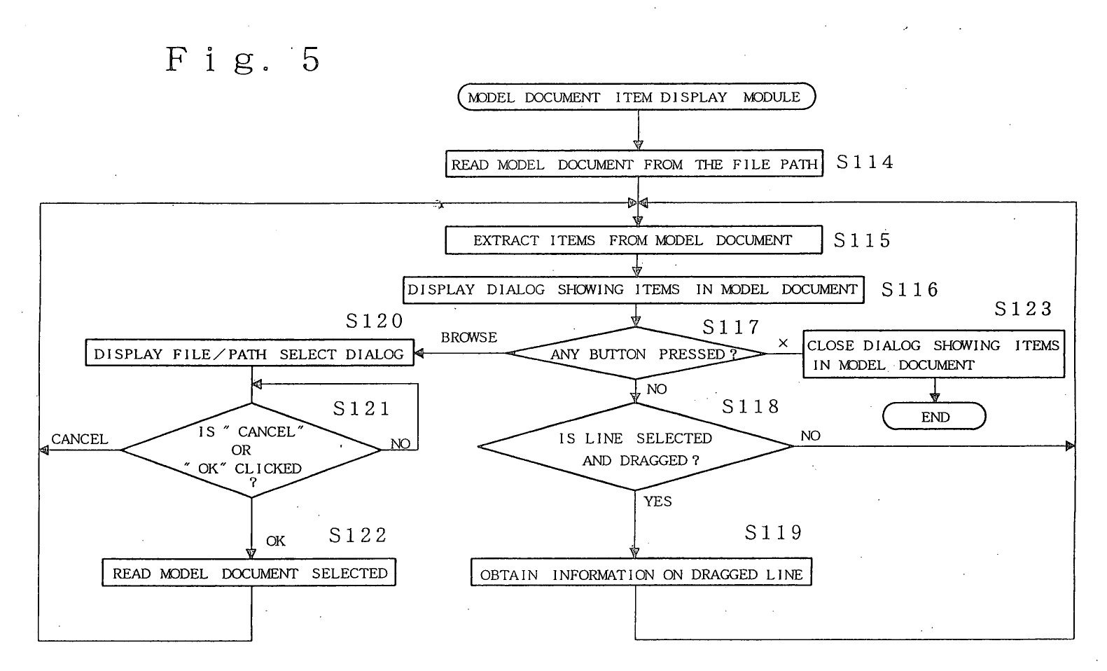

Activating the Creation support program for screen definition for general purpose wizard 35 at S009, the CPU 10 executes the support process for creating screen definition for general purpose wizard shown in FIGS. 4 and 5 in accordance with the creation support program for screen definition for general purpose wizard 35. At S100 which is the first step since the beginning of this support process for creating a screen definition for general purpose wizard, the CPU 10 displays the dialog for creation support as to screen definition for general purpose wizard 44 shown in FIG. 11 or 14 over the dialog for component creation 41. Here, at the time when S100 is executed, the tree list box 443 in the dialog for creation support as to screen definition for general purpose wizard 44 displays the dialog number “Dialog 1” alone. The “Dialog title” text box 4441 is left blank, and the item list 4442 has no line to be written specific entries into.

Next, at S101, the CPU 10 utilizes the function of the operating system 30 to check whether or not any new text entry has been made since the previous execution of S101. If any new text entry has been made, the CPU 10 sets (writes) the character string having been entered so far to the display position of the text entry cursor in the dialog for creation support as to screen definition for general purpose wizard 44. Here, it is possible to set character strings into all the input items in the dialog for creation support as to screen definition for general purpose wizard 44 (the “Dialog title” text box 4441, and the blank fields in the item list 4442).

Then, at S102, the CPU 10 checks whether or not any of the buttons 4421-4426 on the dialog for creation support as to screen definition for general purpose wizard 44 is clicked. If any of the buttons 4421-4426 is clicked, the CPU 10 analyzes the name of the button clicked at S105, and executes the process (S106-S112) according to the name of the button clicked. In contrast, if none of the buttons is clicked, the CPU 10 checks whether or not any line displayed in the dialog for model creation application 43 is dragged and dropped on any line in the item list 4442 in the dialog for creation support as to screen definition for general purpose wizard 44 at S103. If no item line is dropped, then the CPU 10 returns processing to S102.

If the “Add item” button 4423 is clicked while the loop processes S101-S103 is executed repeatedly, the CPU 10 advances processing to S109. Here at S109, the CPU 10 adds a new line to the item list 4442 in the dialog for creation support as to screen definition for general purpose wizard 44, and then returns processing to S101.

If any line displayed in the dialog for model creation application 43 is dropped on any line in the item list 4442 in the dialog for creation support as to screen definition for general purpose wizard 44 while the loop processes S101-S103 is executed repeatedly, the CPU 10 advances processing to S104. Here at S104, the CPU 10 analyzes the information as to the line (that is, item name, tag, type, initial value, the presence/absence of a list box, and whether or not the entry is crucial). The pieces of information analyzed are set into the respective fields “Item name,” “Tag” (in a word processor document only), “Type,” “Initial value,” “List box,” and “Crucial” At the same time, each of the item names associated with the certain dialog displayed in the item list 4442 is also displayed below the dialog number of that dialog 44 in the tree list box 443. Having completed this S104, the CPU 10 returns processing to S101.

If the “Delete item” button 4434 is dicked while the loop processes S101-S103 is executed repeatedly, the CPU 10 advances processing to S108. Here at S108, the CPU 10 deletes the line on which the text entry cursor is currently displayed in the item list 4442, and returns processing to

If the “Add dialog” button 4421 is dicked while the loop processes S101-S103 is executed repeatedly, then the CPU 10 advances processing to S107. Here at S107, the CPU 10 adds a new dialog number into the tree list box 443, removes the underline from the dialog number having been underlined, and applies an underline to the new dialog number. At the same time, the contents having been displayed in the “Dialog title” text box 4441 and the item list 4442 are stored as the information related to the dialog number having been underlined, and the “Dialog title” text box 4441 and the item list 4442 are then reset in preparation for the information setting with the new dialog number. Having completed this S107, the CPU 10 returns processing to S101.

If any of the dialog numbers displayed in the tree list box 443 is clicked while the loop processes S101-S103 is executed repeatedly, the CPU 10 advances processing to S106. Here at S106, the CPU 10 removes the underline from the dialog number having been underlined, and applies an underline to the dialog number clicked. At the same time, the contents having been displayed in the “Dialog title” text box 4441 and the item list 4442 are stored as the information related to the dialog number having been underlined, and the “Dialog title” text box 4441 and the item list 4442 are refreshed on the basis of the information stored in association with the newly-underlined dialog number. Having completed this S106, the CPU 10 returns processing to S101.

If the “Delete dialog” button 4422 is clicked while the loop processes S101-S103 is executed repeatedly, the CPU 10 advances processing to S108. Here at S108, the CPU 10 deletes the dialog number on which the text entry cursor is having been displayed in the tree list box 443, erases the information stored in association with this dialog number, and decrements by one the dialog numbers) following the deleted dialog number. Having completed this S108, the CPU 10 returns processing to S101.

If the “display items in model document” button 4425 is clicked while the loop processes S101-S103 is executed repeatedly, the CPU 10 advances processing to S111. Here at S111, the CPU 10 exchanges messages with the component creation support program 31 to obtain the file path of the model document file 38. Then, at S114, the CPU 10 activates the model document item display module which constitutes part of the creation support program for screen definition for general purpose wizard 35. Then, the CPU 10 returns processing to S101 while executing processes in parallel under the model document item display module.

In the processing under the model document item display module, the CPU 10 reads the model document file 38 based on the file path obtained at S113, at the first step S114 in the flowchart shown in FIG. 5.

Then, at S115, the CPU 10 extracts enterable items from the model document file 38 read at S114 or S122, and analyzes the information as to the items (which are “Item name,” “Type,” “Initial value,” and whether or not “Entry required” in the case of a class definition document; “Item name,” “Tag,” “Type,” and “Table item” in the case of a word processor document).

Then, at S116, the CPU 10 displays the dialog showing items in model document 45 corresponding to the model document file 38 which is read at 5114, beside the dialog for creation support as to screen definition for general purpose wizard 44. Then, the CPU 10 writes the analyzed information as to the items extracted at S115, into the detail table 454 in the dialog showing items in model document 45.

Then, at S117, the CPU 10 checks whether the browse button 4522 or the close button 4511 in the dialog showing items in model document 45 is clicked. If none of the buttons is clicked, the CPU 10 checks whether or not any line in the detail table 454 in the dialog showing items in model document 45 is selected and dragged at S118. When a drag is made in this detail table 454, the entire line under the mouse cursor position is dragged together. If none of the lines is dragged, the CPU 10 simply returns processing to S115.

On the other hand, if any line is dragged and dropped into the item list 4442 in the dialog for creation support as to screen definition for general purpose wizard 44, the CPU 10 sets the respective pieces of information included in the item line dragged, such as “Item name,” into the corresponding fields of the dropped line in the item list 4442 on the dialog for creation support as to screen definition for general purpose wizard 44, at S119. Having completed this S119, the CPU 10 returns processing to S115.

If it is found at S117 that the browse button 4522 in the dialog showing items in model document 45 is clicked, the CPU 10 displays the file/path select dialog 46 shown in FIG. 7 over the dialog showing items in model document 45 at S120. Next, at S121, the CPU 10 waits until the “OK” button 446 or the “Cancel” button 467 in the file/path select dialog 46 is clicked. If the “Cancel” button 467 is clicked, the CPU 10 simply returns processing to S115. On the other hand, when the “OK” button 466 is clicked, the CPU 10 advances processing to S122.

At S5122, the CPU 10 sets the file name displayed in the “File name” text box 464 in the file/path select dialog 46 at that time (in this case, the file name of a model document file 38) into the “Model file name” text box 4521 on the dialog showing items in model document 45. Having completed this S112, the CPU 10 returns processing to S115.

If it is found at S117 that the close button 4511 in the dialog showing items in model document 45 is clicked, the CPU 10 doses the dialog showing items in model document 45 at S123. Then, the CPU 10 terminates this processing with the model document item display module.

Returning to FIG. 4, if the close button 4411 is clicked while the loop processes S101-S103 is executed repeatedly, the CPU 10 simply terminates this support process for creating a dialog for screen definition for general purpose wizard.

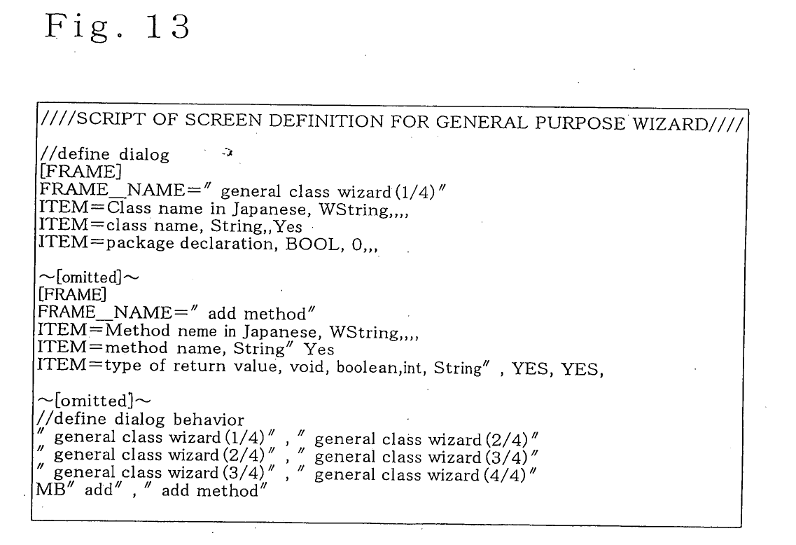

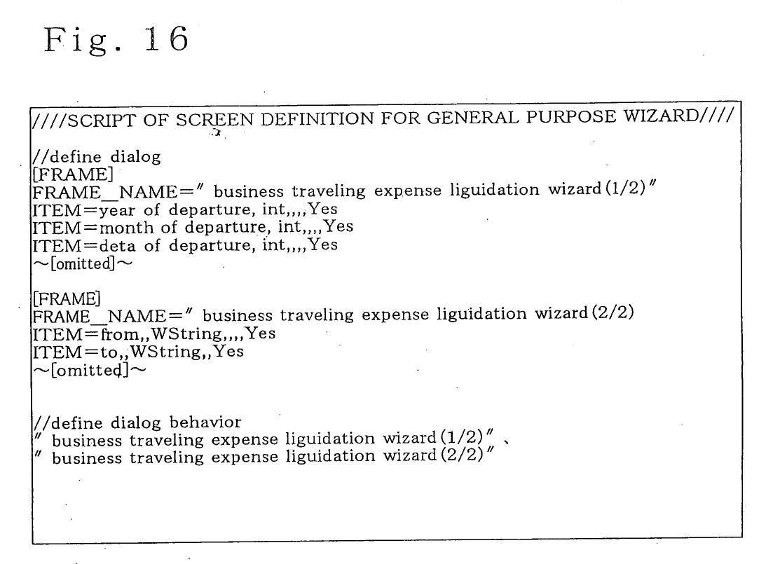

If the “Generate screen definition” button 4426 is clicked while the loop processes S101-S103 is executed repeatedly, the CPU 10 creates a script file for screen definition 39 as shown in FIG. 13 (for a class definition file) or in FIG. 16 (for a word processor document) at S112 based on the information stored in association with the respective dialog numbers currently displayed in the tree list box 443. Then, the CPU 10 attaches the file name set in the wizard of “General purpose” text box 4109 in the dialog for component creation 41 to the created script file. Then, the CPU 10 stores this script file for screen definition 39 into the folder designated by the path name set in the “Destination path” text box 4106 in the dialog for component creation 41. Having completed this S112, the CPU 10 terminates this support process for creating a screen definition for general purpose wizard.

Returning to FIG. 3, if distinguishing at S006 that the close button 4119 or the “Cancel” button 4118 in the dialog for component creation 41 is clicked, the CPU 10 simply terminates this component creation support process.

If distinguishing at S006 that the “Create component information file” button 4117 (i.e., when a request for creating an electronic document creation support data component is entered), the CPU 10 advances processing to S013. Here at S013, the CPU 10 creates a component information file 36 as shown in FIG. 17, based on the entries set in the following fields in the dialog for component creation 41: the “Component name” field 101, the “Version” text box 4102, the “Author” text box 4103, the “Note” text box 4104, the “URL” text box 4105, the “Model file name” text box 4108, the wizard “General purpose” text box 4109 (only if “General purpose” is selected), the wizard of “File designation” text box 4110 (only if “File designation” is selected), and the “Help file” text box 4111. Then, the CPU 10 attaches the file name set in the “Component information file name” text box 4107 in the dialog for component creation 41 to the component information file 36, and stores this file into the folder designated by the path name set in the “Destination path” text box 4106. Having completed S013, the CPU 10 terminates this component creation support process.

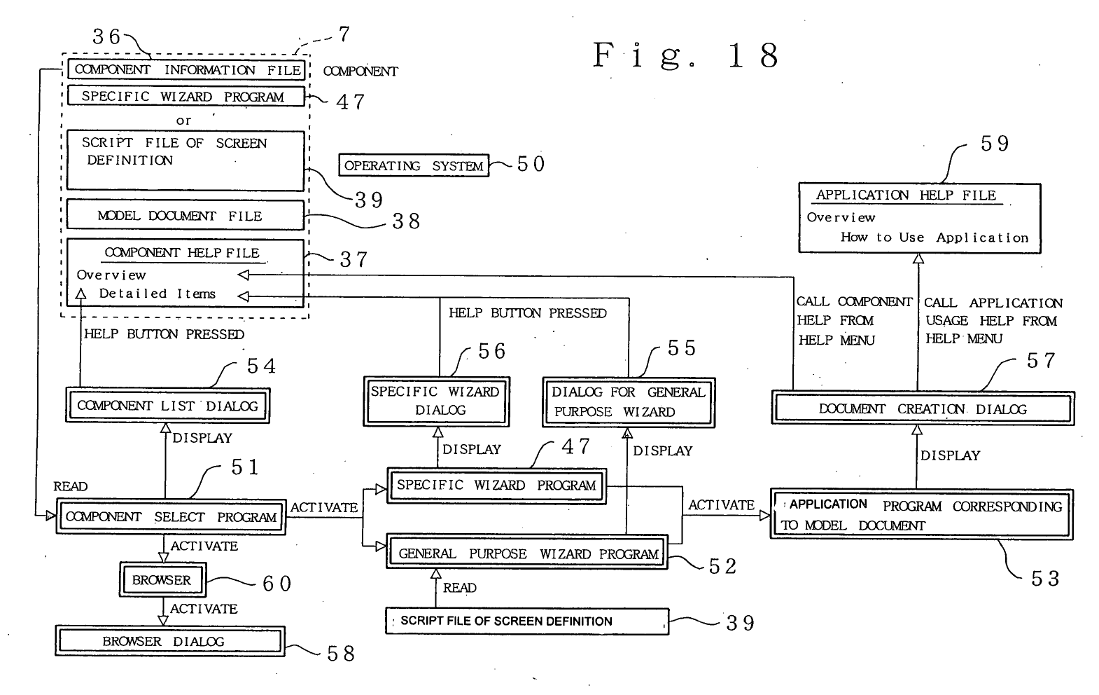

Subsequently, the CPU 10 writes a group of components 7 (see FIG. 18) stored in an identical folder as a result of the component creation support process, namely, component information files 36 and those files associated with one another by the component information files 36, i.e., help file 37, model document file 38, and script file for screen definition 39 or component specific wizard program 47, into the floppy disk 3 via the floppy disk drive 12, or sends the same to the network 4 through the modem 13.

<Electronic Document Creating Computer>

[Hardware Configuration]

As shown in FIG. 1, the electronic document creating computer 2 serving as the electronic document creation support apparatus comprises a CPU 20, a RAM 21, a floppy disk drive (FDD) 22, a modem 23, a display 24, a hard disk (HDD) 25, and interfaces 26 and 27, which are connected to one another via a bus B. The electronic document creating computer 2 further comprises a keyboard 38 connected to the interface 26, and a mouse 39 connected to the other interface 27.

The floppy disk drive 22 is a disk drive for reading various file data stored in the floppy disk 3 (for example, a component information file 36, a help file 37, a model document file 38 and a script file for screen definition 39 or the component specific wizard program file 47 constituting a component 7).

The modem 23 is a communication device which receives communication signals from the network 4 and demodulates the same into a form that the CPU 20 can process. Accordingly, when communication signals corresponding to any of the components 7 are transmitted from the component creating computer 1, the modem 23 demodulates the component information file 36, the help file 37 and the script file for screen definition 39 or the component specific wizard program 36 constituting the component 7, and passes the same to the CPU 20.

The hard disk 25 is a storage device serving as the computer readable medium containing the variety of programs (an operating system 50, a component list select program 51, a general purpose wizard program 52, application programs 53, a Web browser 60, and the like) and the various data shown in FIG. 18. The inside of this hard disk 25 is logically sectioned into folders of multilevel hierarchy. The variety of file data read from the floppy disk 3 or demodulated by the modem 23 (the component information files 36, the help files 37, the model document files 38, and the script files for screen definition 39 or the component specific wizard program files 47) are stored into a folder in the hard disk 25. In this hard disk 25, those areas (sectors) containing the component information files 36 (model spacfic data), the help files 37 (explanatory text data), the model document files 38 (i.e., models of electronic document), and the script files 29 for screen definition 39 or the component specific wizard program files 47 (i.e., item entry support data) correspond to the first storage medium. Those areas (sectors) containing the application programs 53 (editing programs) correspond to the second storage medium. Those areas (sectors) containing the component list select program 51 (support program) correspond to the third storage medium.

The CPU 20 is a processing unit which reads various programs from the hard disk 25 and executes the same to perform predetermined processing. The processes for the CPU 20 to perform will be described later in detail.

The RAM 21 is a work memory in which the programs read from the hard disk 25 by the CPU 20 are expanded and the component specific wizard program files 47 in the components 7 are expanded, and to which the variety of files in the components 7 (the component information files 36, the help files 37, the model document files 38 and the script files for screen definition 39) are read in.

The display unit 24 displays various dialogs generated by the CPU 20 executing the variety of programs mentioned above (namely, a component list dialog 54 generated when the component list select program 51 is executed, a dialog for general purpose wizard 55 generated when the general purpose wizard program 52 loaded with the script file for screen definition 39 is executed, a document creation dialog 57 generated when an application program 53 is executed, and a browser dialog 58 formed when the browser 60 is executed).

The keyboard 28 serving is an input device through which the operator of the electronic document creating computer 2 inputs various text. The interface 26 connected between this keyboard 28 and the bus B is an I/O device which converts a signal indicating a pressed key on the keyboard 28 into corresponding code information, and inputs the same to the CPU 20.

The mouse 29 serving as another input device is a pointing device which is moved over a plane by the operator to generate a signal indicating its moving direction and moving amount at all times. The mouse 29 has a click button (not shown) to be pressed by the operator, and generates a dick signal when this click button is pressed. The interface 27 converts these signals into code information, and inputs the same to the CPU 20.

[Software Configuration]

Now, referring to FIG. 18, an overview will be given of the variety of programs stored in the hard disk 25 (which are the operating system 50, the component select program 51, the general purpose wizard program 52, the application programs 53, the Web browser 60, and the like), the component specific wizard programs in the components 7, and the variety of dialogs (which are the component list dialog 54, the dialog for general purpose wizard 55, the document creation dialog 57, the browser dialog 58, a specific wizard dialog 56, and the like).

The operating system 50 is a basic program for controlling the operation of the various pieces of hardware constituting the electronic document creating computer 2. To be more specific, the operating system 50 is Windows 98™ from Microsoft Corp.

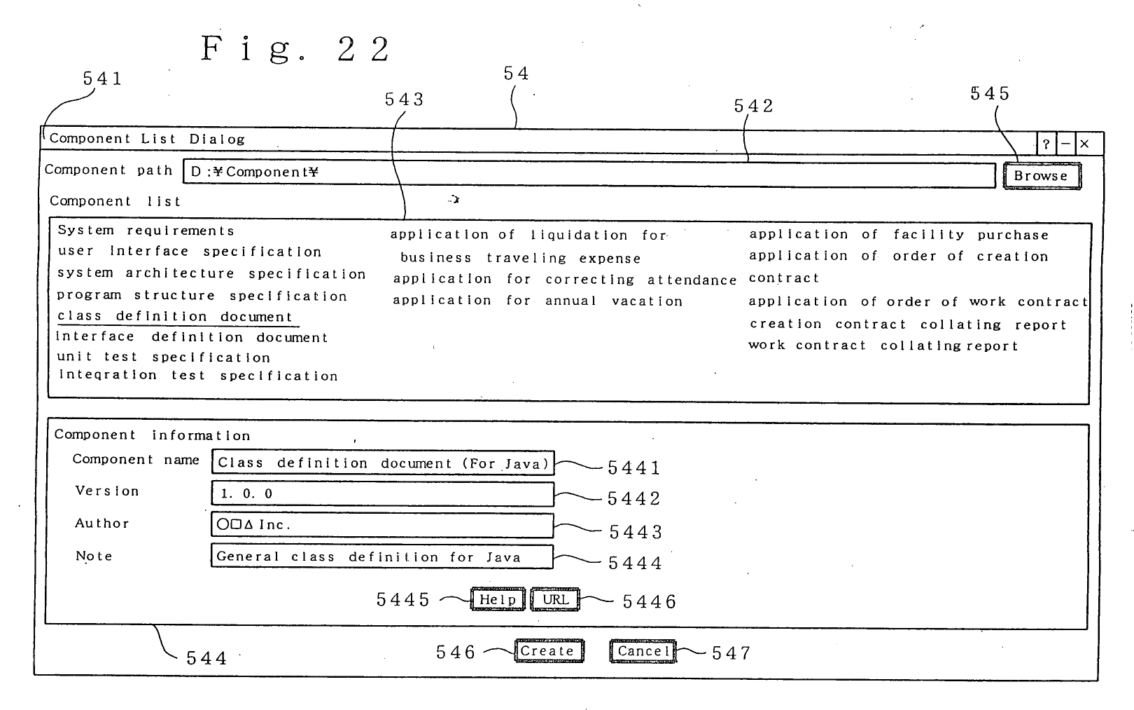

The component select program 51 serving as the support program makes the CPU 20 display the component list dialog 54 shown in FIG. 22, onto the display unit 24. Besides, the component select program 51 makes the CPU 20 activate the component specific wizard program 47 or the general purpose wizard program 52, an application program 53 corresponding to the extension of the file name of the model document file 38 in the component 7, and the browser 60 in accordance with a command input by the operator through the keyboard 28 and the mouse 29. The component list select program 51 also makes the CPU 20 display the contents of the help file 37 in the component 7, onto the display unit 24.

As shown in FIG. 22, the component list dialog 54 is sectioned into a title bar 541 displayed along the upper border, a “Component path” text box 452 and a “Browse” button 545 displayed in line therebelow, a “Component list” text box 543 displayed therebelow, a “Component information” text box 544 displayed therebelow, and a “Create” button 546 and a “Cancel” button displayed in line therebelow. In the “Component list” text box 543 are listed the “component names” which are extracted from the respective component information files 36 (those files with a file name extension of “CDT”) in the folder designated by the path name displayed in the “Component path” text box 542. When any of the “component names” displayed in this “Component list” text box 542 is clicked, that “component name” is selected by the component list select program 51 and an underline is displayed under the “component name.” The “Component information” text box 544 includes a “Component name” filed 5441; a “Version” text box 5442, a “Author” text box 5443 and a “Note” text box 5444, along with a “Help” button 5445 and a “URL” button 5446. In these fields 5441-5444, the corresponding pieces of information in the component information file 36 containing the “component name” selected in the “Component list” text box 543 are extracted and displayed by the component select program 51.

A component specific wizard program 47 is the specific wizard program corresponding to the “component name” selected in the “Component list” text box 543 in the component list select dialog 54 (i.e., the specific wizard program whose file name is specified in the component information file 36 corresponding to the “component name” selected). The component specific wizard program 47 is programmed exclusively for the model document file 38 corresponding to that “component name” (i.e., the model document file whose file name is specified in the component information file 36 corresponding to the “component name” selected). This component specific wizard program 47 makes the CPU 20 display one or a plurality of wizard dialog(s) 56 in sequence to have texts entered to predetermined crucial items in the model document file 38 so that the texts entered through the wizard dialog (s) 56 are written to the coresponding positions in the model document file 38.

In contrast, the general purpose wizard program 52 which is programmed to be applicable to various types of files, reads the script file for screen definition 39 corresponding to the “component name” selected in the “Component list” text box 543 in the component list dialog 54 (i.e., the script file whose file name is specified in the component information file 36 corresponding to the “component name” selected) to make the CPU 20 perform the following operation. That is, the CPU 20 is made to display one or a plurality of dialog of general purpose wizard dialog(s) 55 in sequence to have texts entered to predetermined crucial items in the model document file 38 corresponding to the “component name” selected (i.e., the model document file whose file name is specified in the component information file 36 corresponding to the “component name” selected), so that the texts entered through the dialog for general purpose wizard dialog(s) 55 are written to the corresponding positions in that model document file 38.

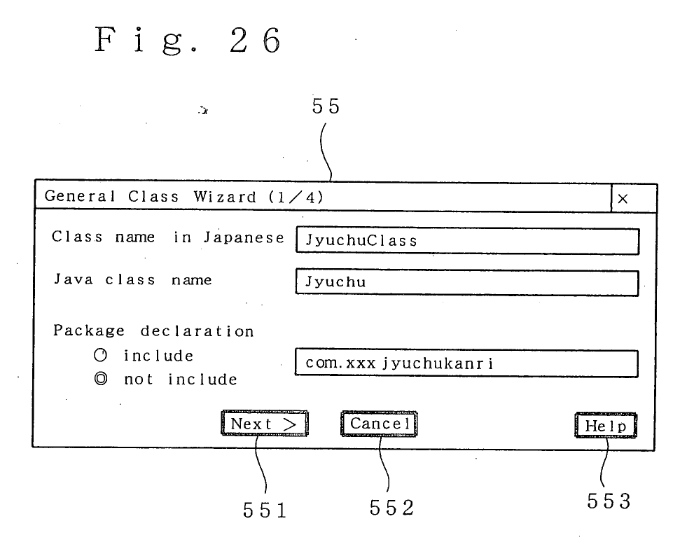

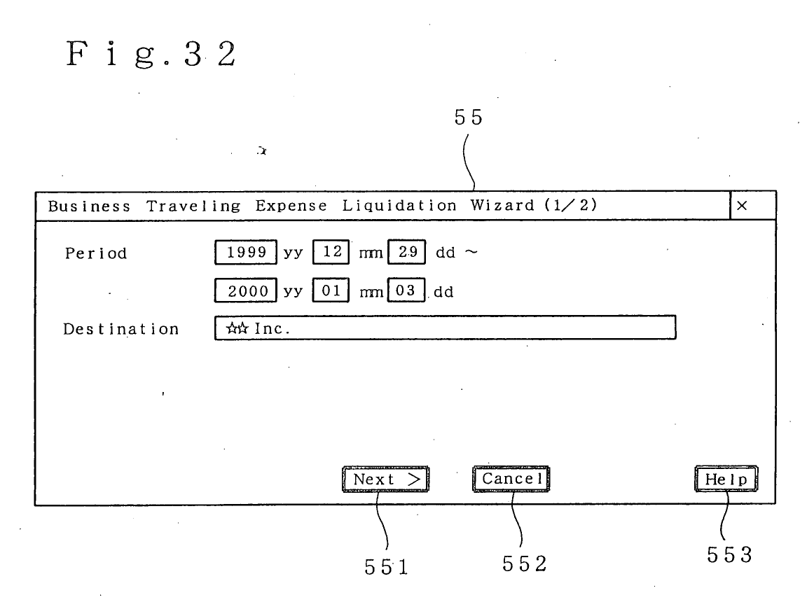

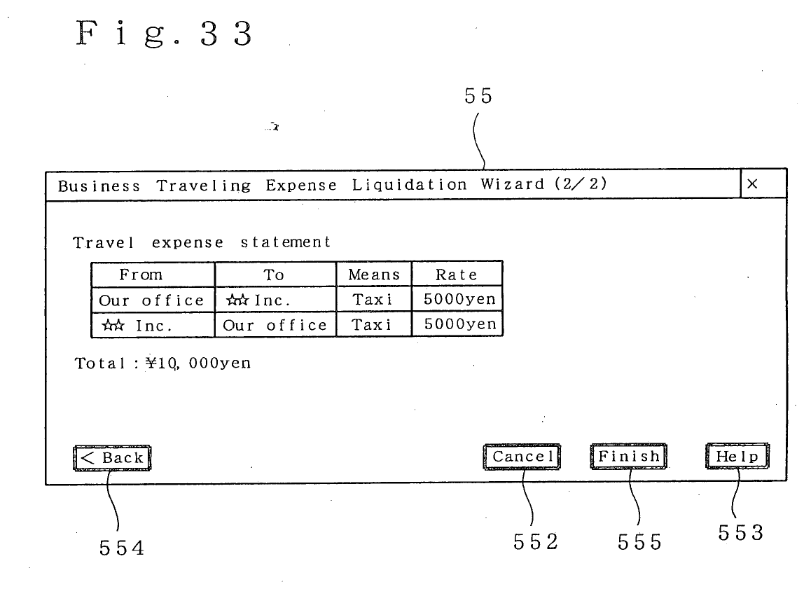

FIGS. 26-29 show examples of the dialog for general purpose wizards 55 in the case where the model document file 38 is the class definition document for Java (of which extension is “FMT”). FIGS. 32 and 33 show examples of the dialog for general purpose wizards 55 in the case where the model document file 38 is the word processor document “application of liquidation for business traveling expense” (of which extension is “DOC”).

The application program 53 serving as the editing programs is a commercially-available application program for editing a model document file 38 corresponding to the “component name” selected in the “Component list” text box 543 in the component list dialog 54 (i.e., the model document file whose file name is specified in the component information file 36 corresponding to the “component name” selected). The application program 53 is the same type of program used as the model creation application programs 34 in the component creating computer 1, and is associated with the extension attached to the file name of the model document file 38, by the component select program 51 in advance. Namely, an extension of “FMT” is associated with a table editor, and an extension of “DOC” is with a word processor. An application program 53 makes the CPU 20 read the model document file 38 to be edited, and display on the display unit 24 a document creation dialog 57 for performing edits on this model document file 38.

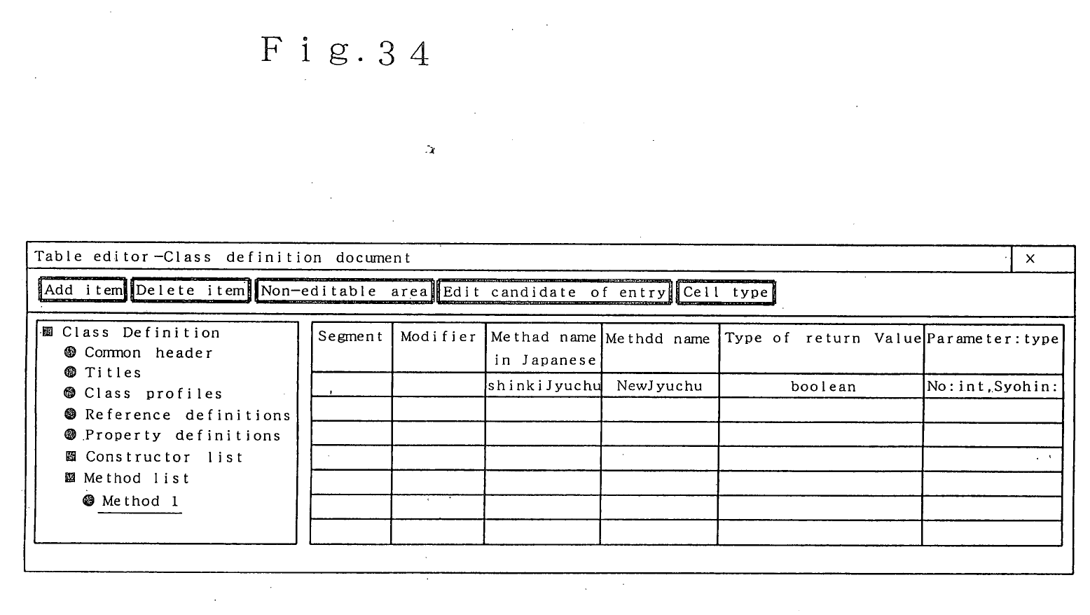

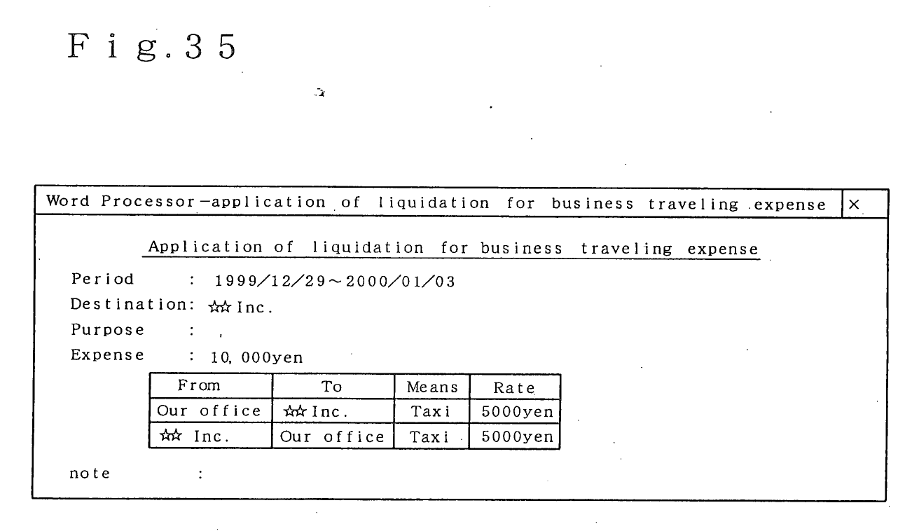

FIG. 34 shows an example of the document creation dialog 57 in the case where the model document file 38 is the class definition document for Java (of which extension is “FMT”). FIG. 35 shows an example of the document creation dialog 57 in the case where the model document file 38 is the word processor document “application of liquidation for business traveling expense” (extension=“DOC”). In either case, the model document file 38 itself has gone through the processing based on either of the wizard programs 47 and 52, and therefore has their crucial items written already. In this connection, it is possible to display the explanatory texts of the detailed items in the help file 37 of the corresponding component 7 from this document creation dialog 57. Besides, when this application program 53 has its help file 59, the contents of the help file 59 (for example, instructions on how to use the application program 53) can also be displayed from this dialog.

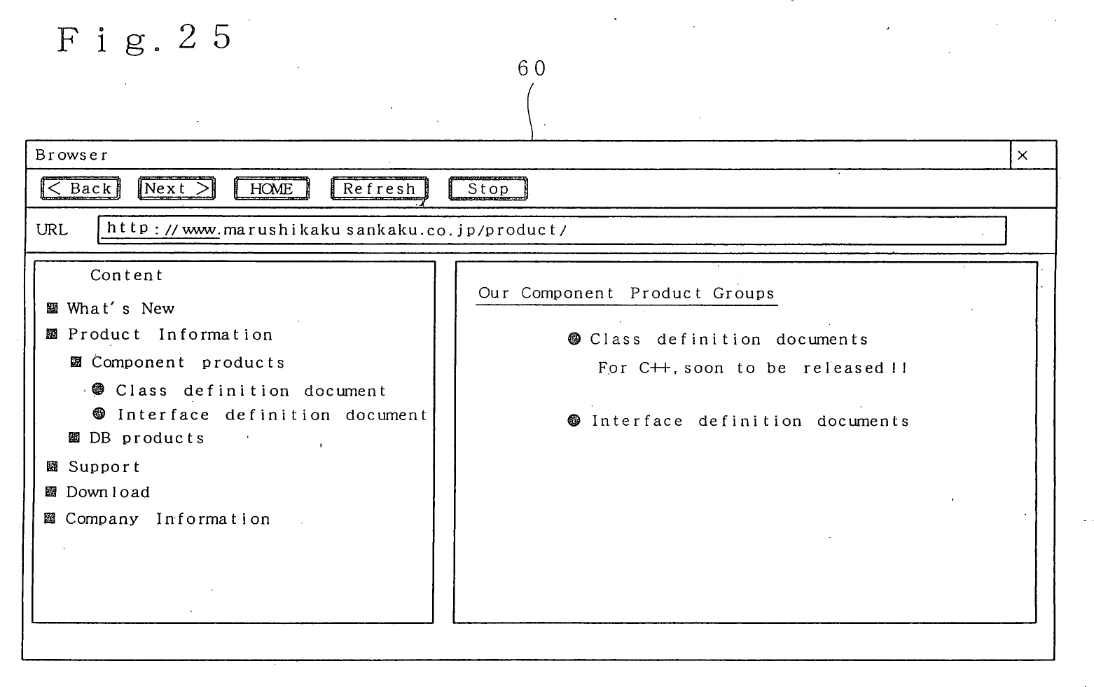

The Web browser 60, when activated by the component select program 51, makes the CPU 20 send the URL corresponding to the “component name” selected in the “Component list” text box 543 in the component list dialog 54 (i.e., the URL specified in the component information file 36 corresponding to the “component name” selected) to the HTML server 5 through the network 4. On receiving the HTML document corresponding to this URL from the HTML server 5, the CPU 20 then displays the browser dialog 58 for displaying the HTML document, onto the display unit 24. This HTML document usually describes the information as to the model document file 38 associated with the URL by the component information file 36. FIG. 25 shows an example of the browser dialog 58 displaying the HTML document concerning the class definition document.

[Process Flow]

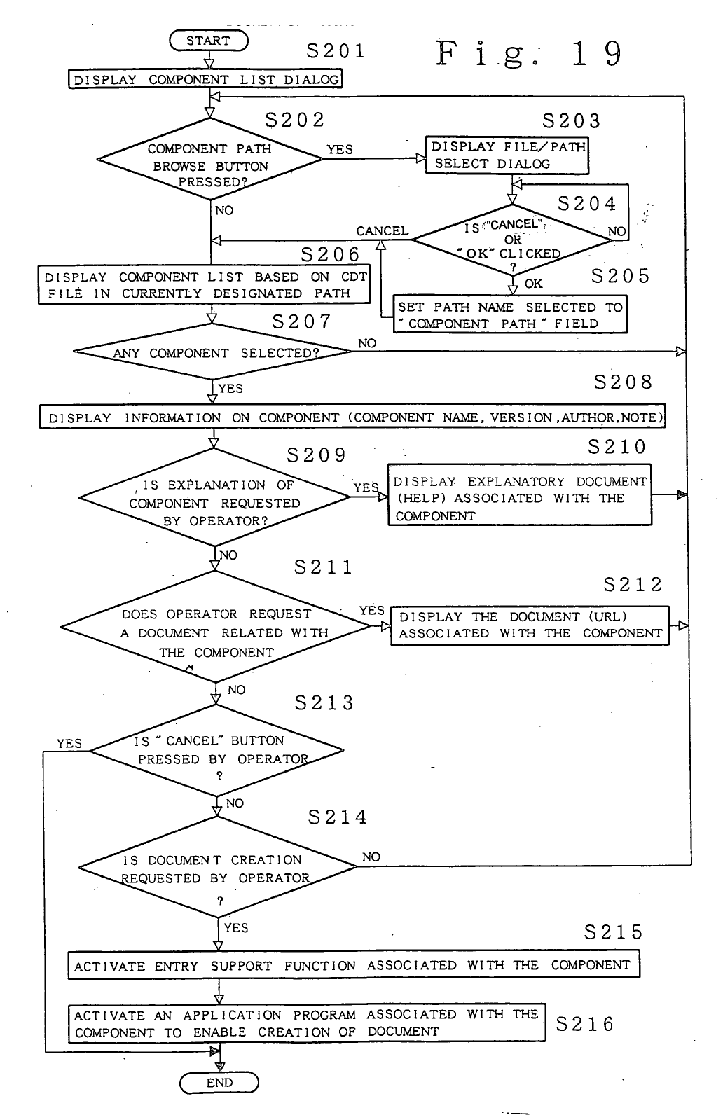

Now, with reference to the flowcharts in FIGS. 19-21, description will be given of the process performed by the CPU 20 having read the variety of programs described above.

FIG. 19 is a flowchart showing the electronic document creation process that the CPU 20 executes under the component list program 51. At S201 which is the first step since the beginning of this electronic document creation process, the CPU 20 displays the component list dialog 54 shown in FIG. 22, onto the display unit 24.

Then, at S202, the CPU 20 checks whether or not the “Browse” button 545 in the component list dialog 54 is clicked. If the “Browse” button 545 is not clicked, the CPU 20 simply advances processing to S206. On the other hand, when the “Browse” button 454 is clicked, the CPU 20 displays the same file/path select dialog 46 as that shown in FIG. 7, onto the display unit 24. Then, at S204, the CPU 20 waits until the “OK” button 466 or the “Cancel” button 467 in the file/path select dialog 46 is clicked. If the “Cancel” button 267 is clicked, the CPU 20 simply advances processing to S206. On the other hand, when the “OK” button 466 is clicked, the CPU advances processing to S205. At S205, the CPU 20 sets the path name currently displayed in the “File location” text box 462 in the file/path select dialog 46 into the “Component path” text box 542 in the component list dialog 54. Having completed S205, the CPU 20 advances processing to S206.

At S206, the CPU 20 reads all the component information files 36 with the “CDT” extension from the folder designated by the path name set in the “Component path” text box 542 in the component list dialog 54. The component names written in the respective component information files 36 are then displayed in the “Component list” text box 543 in the component list select dialog 54.

Next, at 5207, the CPU 20 checks whether or not any of the component names displayed in the “Component list” text box 543 is clicked. If none of the component names is clicked, the CPU 20 returns processing to S202. On the other hand, when any of the component names is clicked, the CPU 20 advances processing to S208.

At S208, the CPU 20 reads the component information file 38 that contains the dicked component name, i.e., the component name underlined in the “Component list” text box 543. The CPU 20 extracts the contents of “Name,” “Version,” “Author,” and “Note” from the component information file 36, and displays the extracted information in the “Component name” text box 5441, the “Version” text box 5442, the “Author” text box 5443, and the “Note” text box 5444 in the component list dialog 54, respectively.

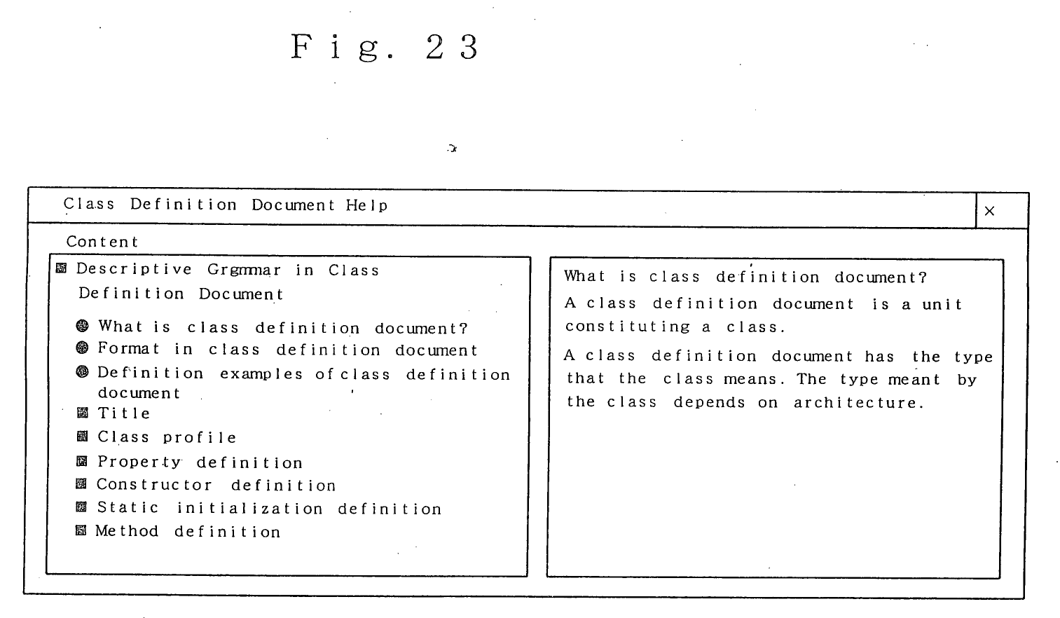

Next, at S209, the CPU 20 checks whether or not the operator clicks the “Help” button 5445 to request the explanations associated with the component 7. If the “Help” button is clicked (i.e., when a request for the explanatory texts is entered), the CPU 20, at S210, extracts the contents of “Help” (i.e., the help file name) from the component information file 36 having been read at S208, and reads the help file 37 having the help file name extracted. Then, the CPU 20 displays the help dialog on the display unit 24, so that the explanation texts of the general items in the help file 37 read in are displayed as shown in FIG. 23. Having completed this S210, the CPU 20 returns processing to S202. On the other hand, when the “Help” button 5445 is not clicked, the CPU 20 advances processing to S211.

Here at S211, the CPU 20 checks whether or not the operator clicks the “URL” button 5446 to request the HTML document associated with the component 7. If the “URL” button 5446 is clicked, the CPU 20 extracts “URL” from the component information file 36 having been read at S208, at S212. Then, the CPU 20 activates the browser 60 to display the browser dialog 58 (see FIG. 25) on the display unit 24. In the meantime, the CPU 20 accesses the HTML server 5, receives the HTML document corresponding to the URL extracted, and displays its contents on the browser dialog 58. Having completed this S212, the CPU 20 returns processing to 5202. On the other hand, when the “URL” button 5446 is not clicked, the CPU 20 advances processing to S213.

Here at S213, the CPU 20 checks whether or not the operator clicks the “Cancel” button 547. If the “Cancel” button 547 is clicked, the CPU 20 immediately terminates this electronic document creation process. In contrast, when the “Cancel” button 547 is not clicked by the operator, the CPU 20 advances processing to S214.

Here at S214, the CPU 20 checks whether or not the operator clicks the “Create” button 546 to request creation of an electronic document based on the model document file 38 associated with that component. If the “Create” button 546 is clicked (i.e., when an edit request for an electronic document is entered), then the CPU 20, at S215, extracts the file name of the script file for screen definition 39 or the file name of the component specific wizard program file 47 from the component information file 36 having been read at S208. When the file name of the script file for screen definition 39 is extracted, the CPU 20 activates the general purpose wizard program 52, and passes the file name and the path name to the wizard program 52. On the other hand, when the file name of the component specific wizard program 47 is extracted, the CPU 20 activates the component specific wizard program 47 designated by the file name. Subsequently, at S216, the CPU 20 extracts the file name of the model document file 38 from the component information file 36 having been read at S208, and reads the model document file 38 having that file name from the folder designated by the path name set in the “Component path” text box 542 in the component list dialog 54. The CPU 20 then activates the application program previously associated with the extension attached to the file name, so that the contents of the model document file 38 are displayed.

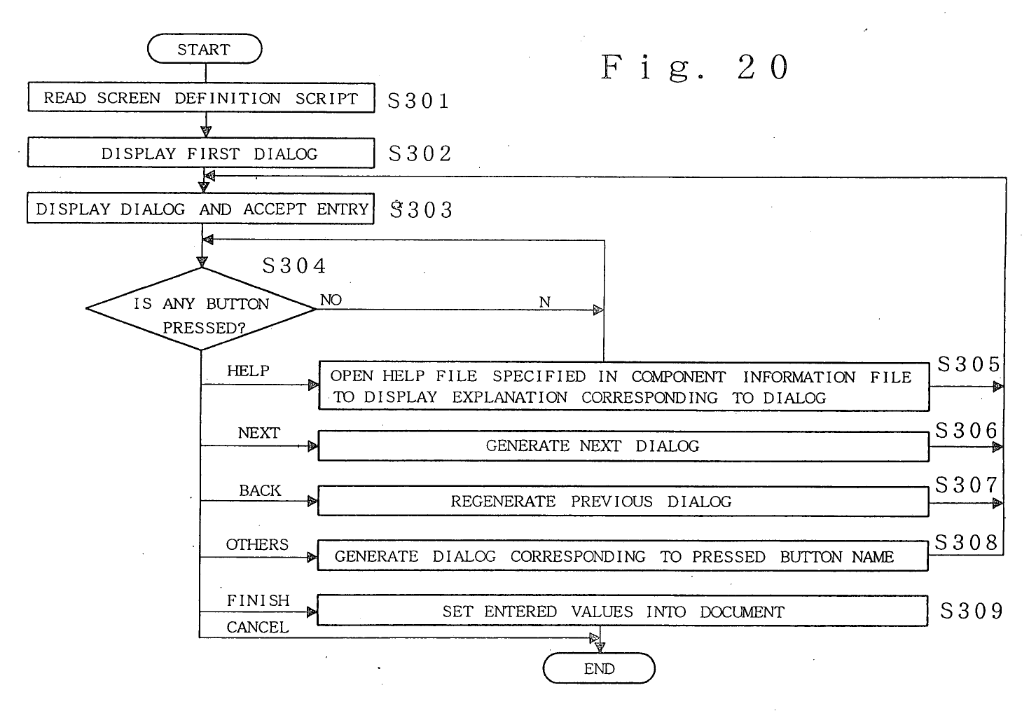

Now, with reference to the flowchart in FIG. 20, description will be given of the processing that the CPU 20 performs under the general purpose wizard program 52 activated at S215.

At S301 which is the step immediately after the activation of the general purpose wizard program 52, the CPU 20 reads the designated script file for screen definition 39 from the designated folder based on the file name and the path name received from the component select program 51.

Next, at S302, the CPU 20 displays the first dialog for general purpose wizard 55 based on the first screen definition [FRAME] in the script file for screen definition 39 having been read at S301. While arrangement of the individual field in the dialog for general purpose wizards 55 depend on the contents of the definition [FRAME], the first dialog for general purpose wizard 55 has a “Next” button 551, a “Cancel” button 552, and a “Help” button 553 displayed along the lower border, under the common format for general purpose wizards. FIG. 26 shows an example of the first dialog for general purpose wizard 55 that is displayed under the script file for screen definition 39 shown in FIG. 13, for use on the class definition document. FIG. 32 shows an example of the first dialog for general purpose wizard 55 that is displayed under the script file for screen definition 39 for use on the word processor document “application of liquidation for business traveling expense,” shown in FIG. 16.

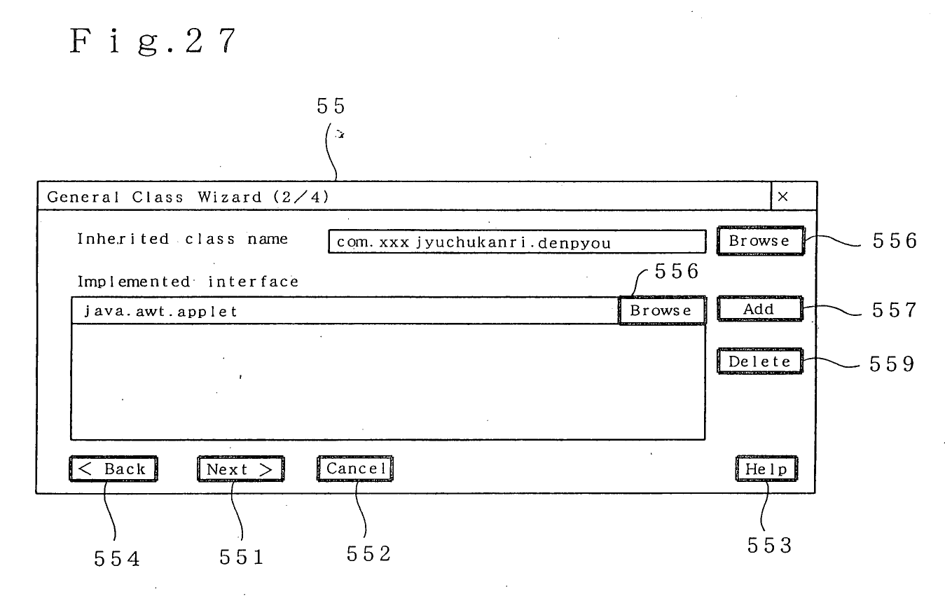

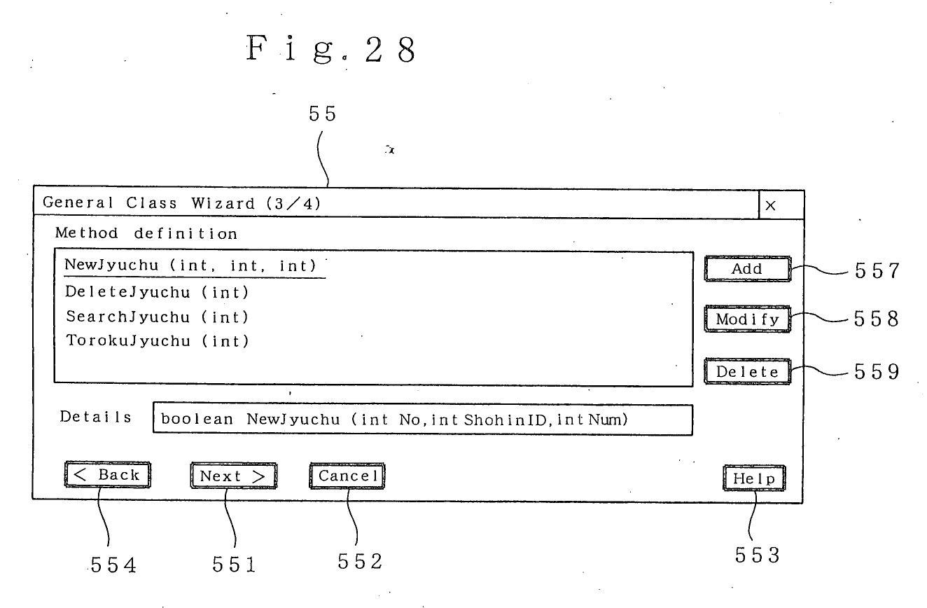

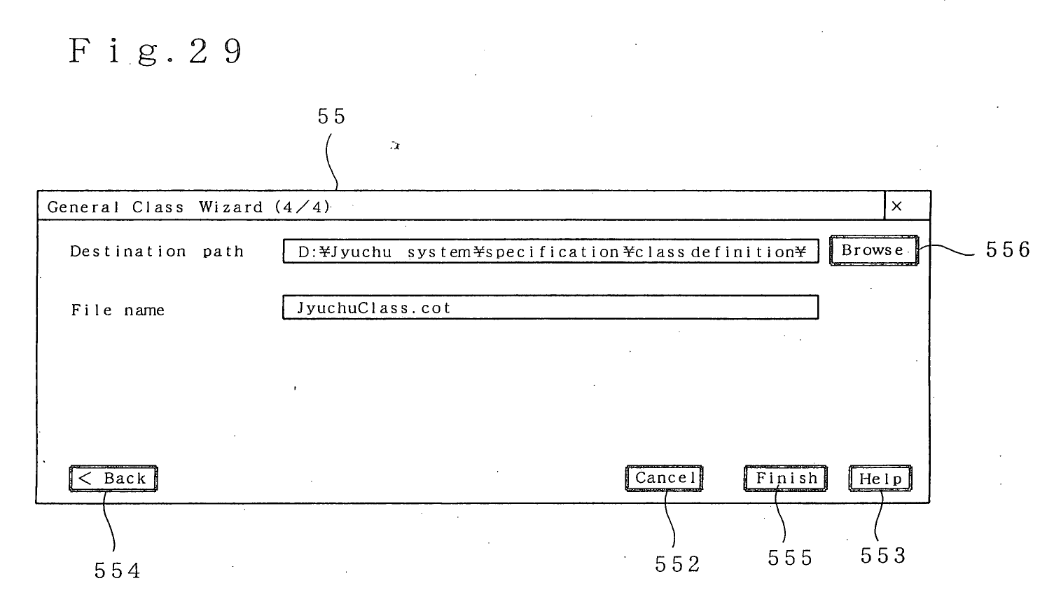

In this connection, the last dialog for general purpose wizard 55 displays a “Back” button 554, the “Cancel” button 552, a “Finish” button 555, and the “Help” button 553 along the lower border under the common format for general purpose wizards. FIG. 29 shows an example of the last dialog for general purpose wizard 55 that is displayed under the script file for screen definition 39 for use on the class definition document, shown in FIG. 13. FIG. 33 shows an example of the last dialog for general purpose wizard 55 that is displayed under the script file for screen definition 39 for use on the word processor document “application of liquidation for business traveling expense,” shown in FIG. 16. Besides, the dialog for general purpose wizard 55 on an intermediate page displays the “Back” button 554, the “Next” button 551, the “Cancel” button 552, and the “Help” button 553 along the lower border under the common format for general purpose wizards. FIGS. 27 and 28 show examples of those dialog for general purpose wizards 55 on intermediate pages, which are displayed under the script file for screen definition 39 for use on the class definition document, shown in FIG. 13.

Next, at S303, the CPU 20 accepts entries to the respective fields in the dialog for general purpose wizard 55 displayed the most currently. That is, the character strings entered through the keyboard 28 are written to the positions where the text entry cursor is displayed in the respective fields.

Next, at S304, the CPU 20 waits until any of the buttons 551-555 on the dialog for general purpose wizard 55 displayed the most currently is dicked. If any of the buttons is clicked, the CPU 20 analyzes the name of the button clicked, and executes the process (S305-S309) according to the name of the button clicked. Hereinafter, description will be given of the clicked buttons and the processes.

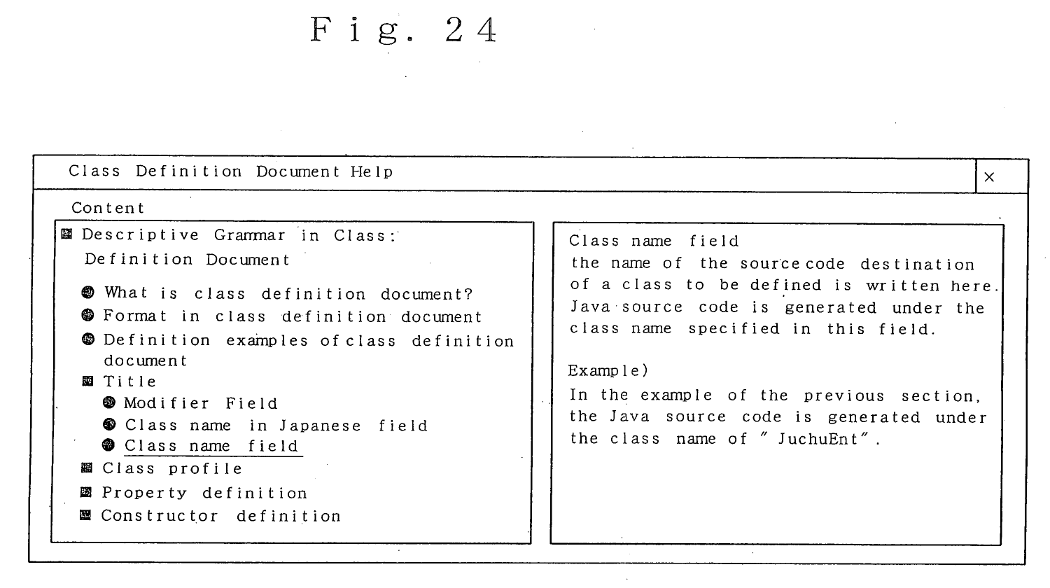

For a start, if the “Help” button 553 is clicked, then the CPU 20, at S305, extracts the contents of “Help” (the help file name) from the component information file 36 having been read at S208. From the help file 37 having the help file name extracted, the CPU 20 reads the explanatory texts on the detailed items corresponding to the respective input items in the dialog for general purpose wizard 55 displayed currently. Then, the CPU 20 displays a help dialog on the display unit 24 to display the read explanatory texts on the detailed items, as shown in FIG. 24. Having completed S305, the CPU 20 returns processing to S304.

If distinguishing that the “Next” button 551 is clicked, the CPU 20 extracts the definition [FRAME] subsequent to the definition [FRAME] of the currently-displayed dialog for general purpose wizard 55, and displays the dialog for general purpose wizard 55 of the next page in accordance with the extracted definition [FRAME] at S306. Having completed S306, the CPU 20 returns processing to S303.

If distinguishing that the “Back” button 554 is clicked, the CPU 20 extracts the definition [FRAME] prior to the definition [FRAME] of the currently-displayed dialog for general purpose wizard 55, and displays the dialog for general purpose wizard 55 of the previous page based on the extracted definition [FRAME], at S307. Having completed S307, the CPU returns processing to S303.

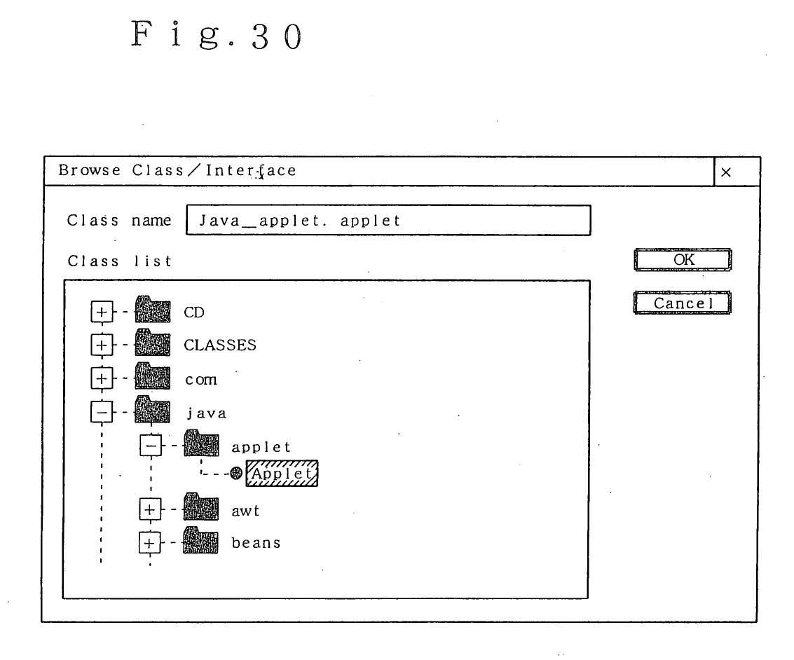

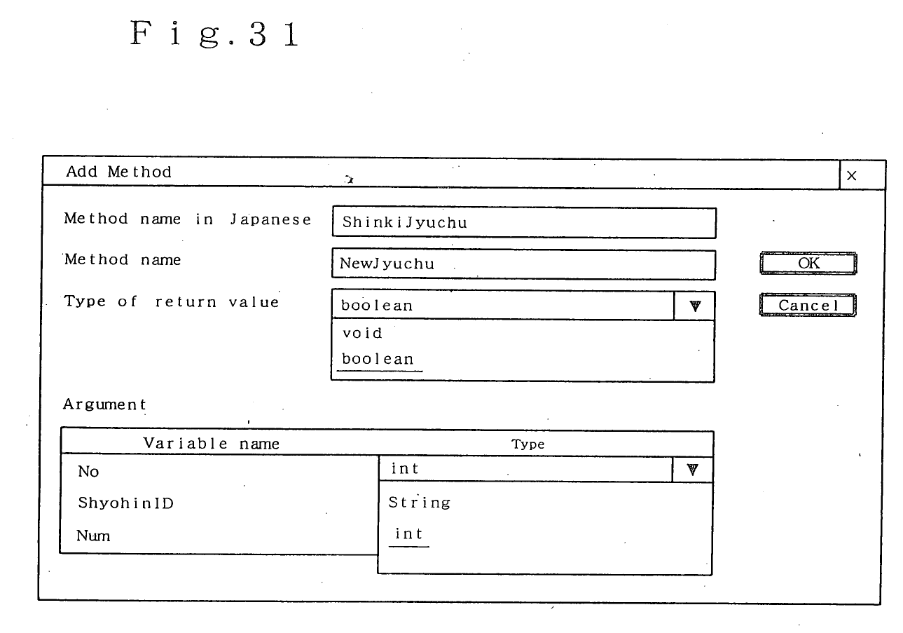

If any button other than the five types of buttons displayed under the general purpose wizard format (which are the “Next” button 551, the “Cancel” button 552, the “Help” button 553, the “Back” button 554, and the “Finish” button 555) is clicked, i.e., when any of the “Browse” button 556 shown in FIGS. 28 and 29, the “Add” button shown 557 in FIGS. 27 and 28, the “Modify” button 558 shown in FIG. 27, and the “Delete” button 559 shown in FIGS. 27 and 29 is clicked, the CPU 20 executes the process corresponding to the button clicked, at S308. For example, when the “Browse” button 556 is clicked, the CPU 20 displays the class/interface browse dialog shown in FIG. 30. This class/interface browse dialog has almost the same function as that of the file/path select dialog shown in FIG. 7. When the “Add” button 557 shown in FIG. 27 is clicked, the CPU 20 displays a dialog to adding method shown in FIG. 31. Having completed S308, the CPU 20 returns processing to the S303.

If the “Cancel” button 552 is dicked, the CPU 20 simply terminates, this general purpose wizard program 52.

If the distinguishing that the “Finish” button 555 is dicked, the CPU 20 passes the character strings written in the fields in the respective general wizard dialogs 55 to the application program 53 having been activated at S216, so that the character strings are set into the corresponding locations in the model document file 38, at S309. FIG. 34 shows the document creation dialog 57 (displayed by a table editor serving as the application program 53) at the point where the general purpose wizard program 52 is completed in accordance with the script file for screen definition 39 for use on the class definition document, shown in FIG. 13. FIG. 35 shows the document creation dialog 57 (displayed by a word processor serving as the application program 53) at the point where the general purpose wizard program 52 is completed in accordance with the script file for screen definition 39 for use on the word processor document “Application of liquidation for business traveling expense,” shown in FIG. 16. Having completed S309, the CPU 20 terminates this general purpose wizard program 52.

On the other hand, the processes by a component specific wizard program 47 vary according to the program descriptions. The processes are, however, no different from those the general purpose wizard program 52 performs with reference to the script file for screen definition 39, in the following point. That is, the operator is prompted to enter character strings to crucial items, and the character strings entered are passed to the application program 53 having been activated at S216 so that the respective strings are set into the corresponding locations in the model document file 38.

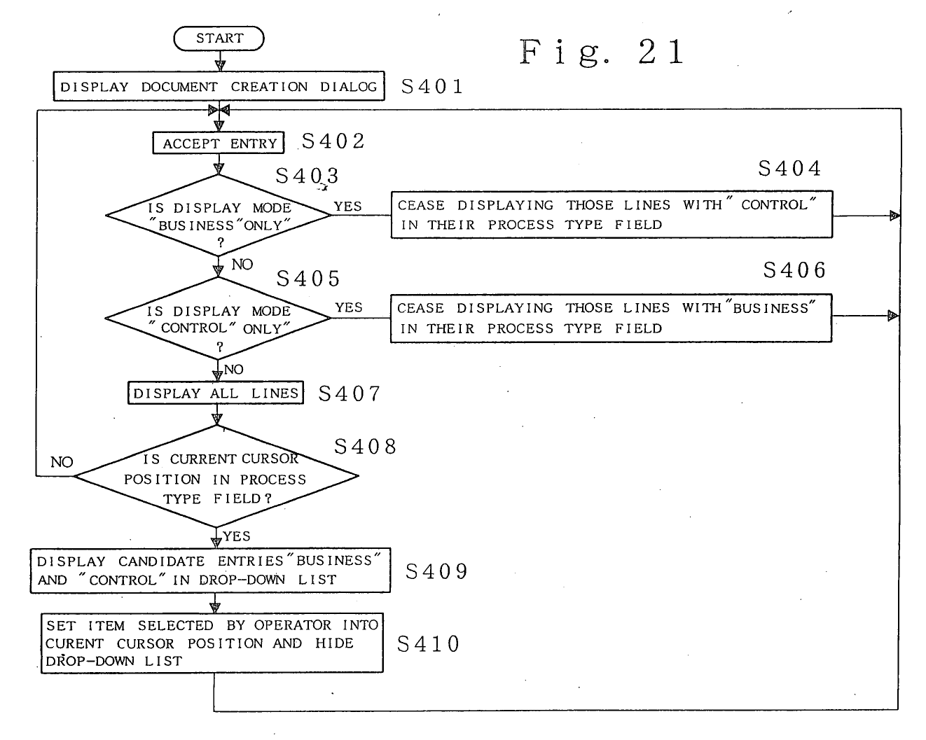

Now, description will be given of the application programs 53 to be activated at S309. The application programs 53 serving as the editing programs perform edits on those model document files 38 that already have their crucial items set by the component specific wizard programs 47 or the general purpose wizard programs 52 in accordance with data input by the operator. These application program are commercially-available ones, and are provided in various types corresponding to the extensions of the model document files 38. Here, with reference to the flowchart in FIG. 21, an overview will be given of the processes by a table editor which is activated in the case where the model document file 38 is the class document file.

At S401 which is the first step since the activation of this table editor, the CPU 20 displays the document creation dialog 57.

Then, at S402, the CPU 20 accepts entries. To be more specific, if having received a model document file 38 from the component list select program 51, the CPU 20 opens the model document file 38 and displays its contents in the document creation dialog 57 as shown in FIG. 34. If having received character strings concerning crucial items from the component specific wizard program 46 or the general purpose wizard program 52, the CPU 20 writes the respective character strings to the corresponding locations in the contents of the model document file 38 displayed on the document creation dialog 57. In the case where the operator has made edit operations, such as entries and deletions of character strings, through the keyboard 38 or the mouse 29, the CPU 20 performs edits on the contents of the model document file 38 displayed in the document creation dialog 57 in accordance with the edit operations.

Moreover, if the operator has entered a display-mode change command, the CPU 20 changes the current display mode to “business only,” “control only,” or “all” in accordance with the change command entered. In this connection, the “business only” display mode is a display mode in which the document creation dialog 57 displays only the lines of BUSINESS process type (which depends on predetermined business) among the lines defined in the class definition document edited by this table editor. The “control only” display mode is a display mode in which the document creation dialog 57 displays only the lines having a process type of “control”(which is to activate programs) among the lines defined in the class definition document edited by this table editor. The “all” display mode is a display mode in which the document creation dialog 57 displays all the lines.

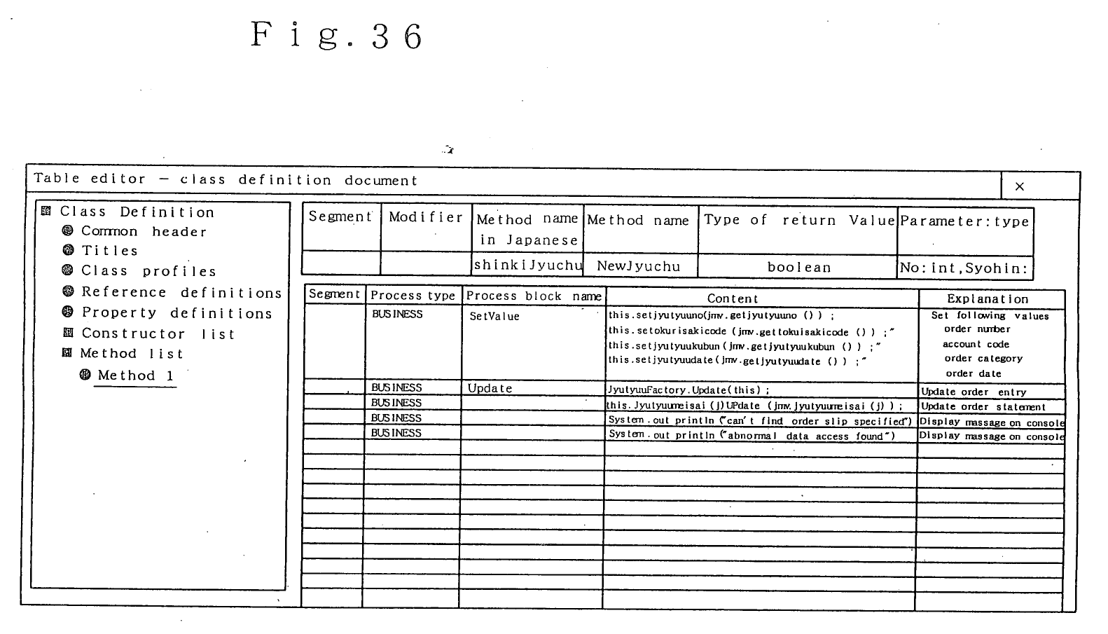

Next, at S403, the CPU 20 checks whether or not the display mode set currently is “business only.” If the display mode is “business only the CPU 20 ceases displaying those lines having a process type of “control” in the document creation dialog 57, at S404. As a result of executing this S404, the document creation dialog 57 displays the contents as illustrated in FIG. 36. Having completed S404, the CPU 20 returns processing to S402. In contrast, when the display mode is not “business only,” the CPU 20 advances processing to S405.

At S405, the CPU 20 checks whether or not the display mode set currently is “control only.” If the display mode is “control only,” the CPU 20 ceases displaying those lines having a process type of “BUSINESS” on the document creation dialog 57, at S406. Having completed S406, the CPU 20 returns processing to S402. On the other hand, when the display mode is not “control only,” the CPU 20 advances processing to S407.

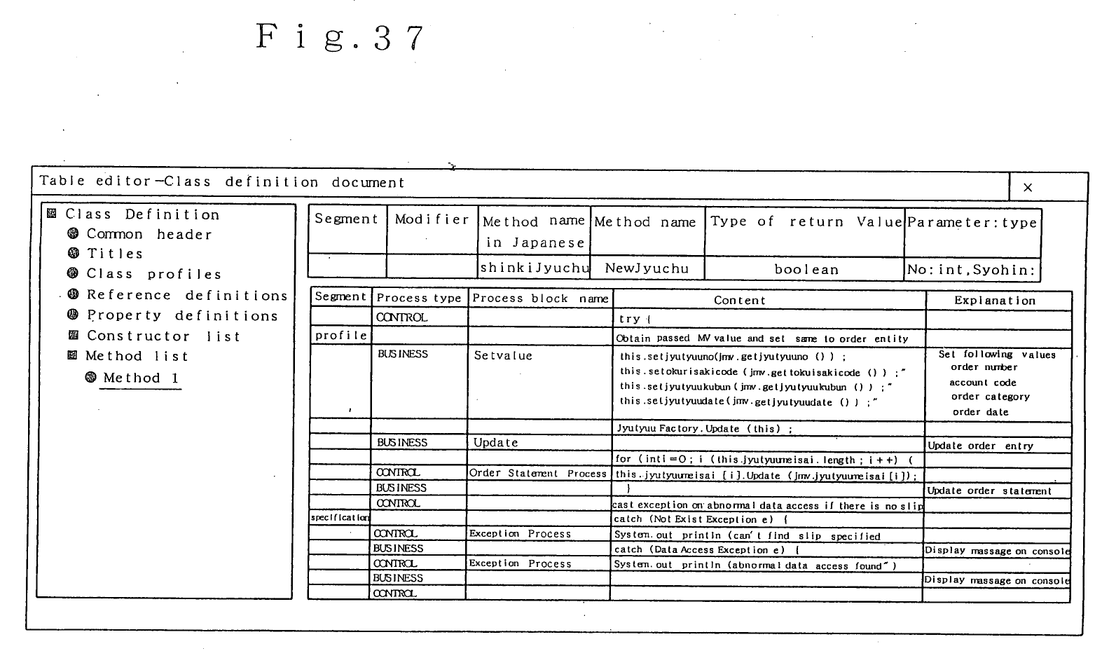

At S407, the CPU 20 determines that the display mode set currently is “all,” and displays all the lines in the document creation dialog 57 as shown in FIG. 37.

Next, at S408, the CPU 20 checks whether or not the text entry cursor displayed currently is placed on a process type field. If the text entry cursor is not displayed in any process type field, the CPU 20 returns processing to S402. On the other hand, when the text entry cursor is displayed in a process type field, the CPU 20 advances processing to S409.

At S409, the CPU 20 displays a group of candidate texts “BUSINESS” and “CONTROL” in the form of a dropdown list, over the process type field where the text entry cursor is displayed.

Next, at S410, the CPU 20 waits until the operator clicks any of the candidate texts with the mouse. Then, the CPU 20 sets the candidate text dicked to the current text entry cursor position, and hides the drop-down list. Having completed S410, the CPU 20 returns processing to S402.

<Function of the Electronic Document Creation Support System>

In the electronic document creation support system described above, a provider of model document uses the component creating computer 1 to create components 7 for the model documents to be edited with the various types of application programs. Each of the components 7 has a model document file 38 describing the contents of the model document, a help file 37 describing the explanatory texts on the model document, a component specific wizard program 47 for performing edits on the model document file 38 or a script file for screen definition 39 to be referred to by the general purpose wizard program 52 to edit the model document file 38, and a component information file 36 which associates these model document file 38, help file 37 and component specific wizard program 47 or script file for screen definition 39 with one another.

The component creation support program 31 to be executed in the component creating computer 1 makes the help creation application program 33 create the help file 37, makes a model document creation application program 34 create the model document file 38, and makes the Creation support program for screen definition for general purpose wizard 35 create the script files for screen definition 39 for the each of the components 7. Then, the component information files 36 are created on the basis of the respective file names of the help file 37, the model document file 38, and the script file for screen definition 39 or the component specific wizard program file 47 created thus.

The various types of components 7 created in this way are stored in the floppy disk 3 (or in any other medium) or transmitted through the network (NW) 4, and supplied to the user, i.e., to the electronic document creating computer 2.

The user which is an operator of the electronic document creating computer 2, activates the component select program 51 so that the names of the components 7 stored in one of the folders in the hard disk 25 on the electronic document creating computer 2 are listed in the “Component list” text box 543 in the component list dialog 54. When the user selects any of the component names thus listed, the information as to the component 7 is displayed in the “Component information” text box 544 in the component list dialog 54. Besides, when the user clicks the “Help” button 5445, the help file 37 associated with the component 7 is read, and the contents thereof are displayed on the help dialog. Moreover, when the user clicks the “URL” button 5446, the HTML document relating to the component is obtained from the HTML server 5 through the network 4 by the browser 60, and the contents thereof are displayed on the browser dialog 58.

When the user clicks the “Create” button 546, the component specific wizard program 47 or the script file for screen definition 39 associated with the component 7 is read. Then, the component specific wizard program 47 or the general purpose wizard program 52 referring to the script file 39 is run and the model document file 37 associated with the component 7 is opened by the corresponding application program 53.

When the user inputs text to crucial items along the wizard dialogs 55 or 56 displayed by either of wizard programs 47 or 52, the character strings input are set into the crucial items in the model document file 38 being edited by the application program 53. Subsequently, the user can simply use the application program 53 to edit the model document file 38, so that the objective electronic document is completed with ease.

Accordingly, in the electronic document creation support system of the present embodiment, the user can refer to the explanatory texts associated with the model document file 38 to be edited (that is, the explanatory texts in the help file 37, the contents of the HTML document) pro re nate. This avoids the need to insert comment statements into the model documents to be displayed on the document creation dialogs 57, thereby resolving the trouble that the visibility of the model documents is deteriorated by the comment statements.

Moreover, in the electronic document creation support system of the present embodiment, when the user specifies a model document file 38 to edit, the wizard program 47 or 52 for performing the processes corresponding to the model document file 38 is activated. Therefore, if the user enters character strings to the items requested by this wizard program 47, 52, these character strings are written to the crucial items in the model document file 38. This prevents the crucial items from being missed out.

As has been described above, according to the electronic document creation support apparatus in the first aspect of the present invention or the computer readable medium containing the electronic document creation supporting data and program for operating a computer as such an electronic document creation support apparatus, it is possible to display explanatory texts corresponding to a “model document” only when desired by the operator.

Moreover, according to the electronic document creation support apparatus in the second aspect of the present invention or the computer readable medium containing the electronic document creation supporting data and program for operating a computer as such an electronic document creation support apparatus, it is possible to make the operator enter crucial items in a model document.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. An electronic document creation support apparatus for editing an electronic document template that is a file used as a template to create objective electronic documents, the apparatus comprising:
an input device;
a display unit for displaying information;
a processing unit to execute processing of programs;
a first storage medium containing an electronic document creation package comprising the electronic document template having a plurality of fields to be filled with concrete information, an item entry support wizard for making said processing unit sequentially set pieces of information entered through said input device to fill fields in an objective electronic document that correspond to the fields in said document template, and a data file comprising packaging information identifying said electronic document template and said item entry support wizard;
a second storage medium containing an editing program for editing said electronic document template and objective electronic documents created therefrom; and
a third storage medium containing a support program, wherein said support program, when being executed by said processing unit, reads said data file to obtain the packaging information therein, and
wherein, when a user request to create an objective electronic document based on said electronic document template is entered through said input device, said support program makes said processing unit read said packaging information and said item entry support wizard corresponding to the packaging information in said data file, sequentially set concrete information into the items of the objective electronic document as entered with said item entry support wizard, and edit the objective electronic document based on the same document template in accordance with said editing program.

2. An electronic document creation support apparatus according to claim 1, wherein
said first storage medium, said second storage medium, and said third storage medium are constructed in an identical storage device.

3. An electronic document creation support apparatus according to claim 1, wherein
said first storage medium contains a plurality of groups of said models, said item entry support data and said model specific data.

4. An electronic document creation support apparatus according to claim 3, wherein
said second storage medium contains a plurality of editing programs of which objective electronic documents are different from each other.

5. An electronic document creation support apparatus according to claim 3,
wherein, when any one of said plurality of model specific data stored in said first storage medium is selected by a designation input through said input device, said support program makes the processing unit read the model specific data selected, and
wherein, when request of edit on an electronic document is entered through said input device, said support program makes said processing unit read said model and said item entry support data corresponding to the specific information in the read model specific data and subject said model to the setting of concrete information into the items according to said item entry support data and the edits in accordance with said editing program.

6. An electronic document creation support apparatus according to claims 1, wherein
said item entry support data is a program.

7. A computer readable medium containing:
an electronic document template file comprising an electronic document template having a plurality of items to be filled with concrete information;
an item entry support wizard read by a processing unit connected to an input device and a display unit and capable of editing said electronic document in accordance with an editing program for making the processing unit sequentially set pieces of information entered through said input device to the plurality of items in said document template;
a data file comprising packaging information identifying said document template and said item entry support wizard; and
a support program read by the processing unit for making said processing unit execute steps of
reading said data file to obtain the packaging information, and,
when a user request to create an objective electronic document based on the document template is entered through said input device, reading said document template and said item entry support wizard corresponding to the packaging information in said read data file, sequentially setting concrete information into the items of the objective electronic document as entered with said item entry support wizard and editing the objective electronic document based on the same document template in accordance with said editing program.

8. A computer readable medium according to claim 7, containing a plurality of groups of said models, said item entry support data and said model specific data, wherein said support program makes the processing unit execute steps of
reading, when any of said plurality of model specific data is selected by a designation input through said input device, the model specific data selected; and
when the request of the edit for an electronic document is entered through said input device, reading said electronic document model and said item entry support data corresponding to the specific information in said read model specific data and subjecting model to the setting of concrete information into the items according to said item entry support data and the edit by said editing program.

9. A computer readable medium according to claim 7, wherein said item entry support data is a program.

10. An electronic document creation support data component creating apparatus for creating an electronic document creation support data component comprising an electronic document template that is a file used as a template to create objective electronic documents and having a plurality of items to be filled with concrete information, an item entry support wizard to be used for sequentially setting pieces of information to said items in said document template or objective documents created therefrom, and a data file comprising packaging data including information identifying said document template and said item entry support wizard, said apparatus comprising:
an input device;
a processing unit to execute processing of programs;
a first storage medium containing an electronic document editing program for editing said electronic document template and objective electronic documents created therefrom;
a second storage medium containing an item entry support wizard program for receiving input of concrete information and setting corresponding fields of an objective document created from the document template; and
a third storage medium containing a component creation support program,
wherein said component creation support program makes said processing unit
perform creation of said document template with said electronic document editing program when a request of creating the document template is entered through said input device,
perform creation of the item entry support wizard with said item entry support data editing program when a request of creating the item entry support wizard is entered through said input device, where said program allows a user to design the item entry support wizard by automatically obtaining enterable items from the document template, and
create packaging data including information identifying said model created with said electronic document editing program and said item entry support wizard created with said item entry support data editing program when a request of creating an electronic document creation support data component is entered through said input device.
